(19) United States
(12) Patent Application Publication
(10) Pub. No.: US 2026/0071354 A1
(43) Pub. Date: Mar. 12, 2026

(54) SYSTEM AND METHOD FOR MANUFACTURING BAMBOO FIBERS FROM BAMBOO PARTS AND DEVICE AND METHOD FOR MANUFACTURING PRODUCTS FROM BAMBOO PARTS

(71) Applicant: BBF IP B.V., Amsterdam (NL)

(72) Inventor: Marcus Anton Hubertus BOKELOH, Amsterdam (NL)

(21) Appl. No.: 19/107,134

(22) PCT Filed: Sep. 4, 2023
(86) PCT No.: PCT/EP2023/074173

§ 371 Date: Feb. 27, 2025

(30) Foreign Application Priority Data
Sep. 2, 2022 (NL) 2032944

(51) Int. Cl. D01B 1/46; B02C 23/10; B02C 23/14

(52) U.S. Cl. CPC D01B 1/46; B02C 23/10; B02C 23/14; D10B 2201/10

(57) ABSTRACT

System for manufacturing bamboo fibers from bamboo parts, the system comprising: ⋅—at least one milling device (12) configured for milling the bamboo parts into bamboo fibers, and ⋅—at least one diameter sieve device (18) configured for separating the bamboo fibers in a first width fraction of relatively narrow bamboo fibers and a second width fraction of relatively wide bamboo fibers, wherein the bamboo fibers of the second width fraction have a greater diameter than the bamboo fibers of the first width fraction.

### FIELD OF THE INVENTION

The present invention relates to a system and method for manufacturing bamboo fibers, in particular relatively short bamboo fibers, from bamboo parts. The present invention relates to an assembly and method for manufacturing products from the bamboo parts, in particular sheet material.

### BACKGROUND OF THE INVENTION

Bamboo fiber can be used for various kinds of products. WO2019093898 discloses a system and method of manufacturing bamboo thread from bamboo. The bamboo thread can be used in a similar way as carbon fiber or glass fiber for making various kinds of products.

However, the system and method of WO2019093898 is focussed on manufacturing long bamboo fibers from which thread can then be made. This process requires relatively large bamboo parts as basic material. Such large bamboo parts may not always be available. Also, the relatively long bamboo fibers require a specific production method and device for further processing, in particular for making a thread from bamboo.

In the present invention it was recognized that short bamboo fibers can also be used for manufacturing certain products. Short bamboo fibers can be made with smaller bamboo parts. Further, it was recognized that short bamboo fibers can be manufactured in a highly mechanized and automated manner.

In the present invention, it was further recognized that products which are produced with bamboo fibers can be made in a higher quality when the bamboo fibers have a similar length and a similar lateral dimension (or diameter) and in particular are separated in well-defined fractions of certain diameter and length. These fractions should preferably contain fibers only. The parenchyma should be removed.

US2016/(0)184866A1 discloses a system comprising multiple sieves for sieving bamboo parts and bamboo fibers. In the present invention, it was recognized that this system has several disadvantages. First, steam is used to pre-process the bamboo parts prior to grinding, see par. 131-133. This requires a significant amount of energy and weakens the bamboo parts and fibers. Also, the bamboo parts need to be dried before they can be processed further, which costs time.

Further, the system of US2016/0184866A1 does not or cannot effectively convert the raw material, i.e., the bamboo chips, into purely bamboo fibers. A substantial portion of the bamboo parts is converted into spherical bamboo parts or other bamboo parts having other shapes which are not fiber-shaped. As a consequence, a significant portion of the raw material is lost or at least is not processed into bamboo fibers.

Furthermore, the system of US2016/0184866A1 is not capable of creating multiple fractions of bamboo fibers which are sorted according to both length and diameter. This limits the use and quality of the end products. Furthermore, the system of US2016/0184866A1 is not well suited to remove parenchyma from the bamboo fibers. This disadvantageously affects the quality of the resulting bamboo fibers.

U.S. Pat. No. 5,397,067 discloses a further system for manufacturing bamboo fibers. This system is based on a hammer-mill-type grinding machine. In the present invention it was found that a crusher based on hammers results in bamboo fibers having a relatively short length which is disadvantageous. Further, U.S. Pat. No. 5,397,067 discloses immersing the bamboo fibers. It was found that this results in a loss of strength and a relatively high energy demand, because the fibers subsequently need to be dried.

In the present invention, it was further recognized that a result of a production process of long bamboo fibers as disclosed in WO2019093898 (which production process is not part of the present invention), is that residual fibers remain which are too short for the production of long fiber (intermediate) products, but however can be used for other products made from short bamboo fibers. This results in a significantly better use of the raw material, which is bamboo.

### OBJECT OF THE INVENTION

It is an object of the present invention to create a system and method for producing relatively short bamboo fibers from bamboo parts.

It is an object of the present invention to create a system and method for producing bamboo fibers and (intermediate) products in well-defined separate fractions which are sorted by both length and diameter, and to perform this production process efficiently, with relatively little energy and without compromising the strength of the bamboo fibers.

It is an object of the present invention to create a system and method for producing (intermediate) products from relatively short bamboo fibers, in particular sheet material.

### SUMMARY OF THE INVENTION

In order to achieve at least one object, the invention provides a system for manufacturing bamboo fibers from bamboo parts, the system comprising comprising a diameter subsystem which comprises at least a first set and a second set which are placed in series, each set comprising:
at least one milling device configured for milling the bamboo parts into bamboo fibers, and
at least one diameter sieve device configured for separating the bamboo fibers in a first width fraction of relatively narrow bamboo fibers and a second width fraction of relatively wide bamboo fibers, wherein the bamboo fibers of the second width fraction have a greater diameter than the bamboo fibers of the first width fraction,
   wherein the system comprises a feed trajectory which extends from the diameter sieve device of the first set to the milling device of the second set, for feeding the fraction of relatively wide bamboo fibers which are discharged from the wide diameter exit of the first set to the milling device of the second set.

With the invention, bamboo fibers can be produced which are suitable for manufacturing various (intermediate) products, including sheet material. Bamboo fibers can be manufactured from bamboo parts in an effective and reliable way, and can be efficiently graded in multiple diameter fractions. The multiple subsequent sets of a milling device and a diameter sieve device allow a fraction of relatively wide bamboo fibers which did not pass the first sieve to be milled again and sieved again in a next set of a milling device and diameter sieve device.

It was found that with multiple sets, a relatively high portion by weight of the incoming bamboo parts can be converted into useable bamboo fibers, that is, bamboo fibers having a suitable width. It was recognized that during the milling, the total volume of the bamboo material increases significantly. Bamboo parts are rather solid and bamboo fibers have a substantial amount of air between them. It is the air between the fibers which causes the increase in volume. The increase in volume makes it less practical to redirect the larger fibers which have not passed the diameter sieve in a return flow to the same milling device and remill the large fibers in the same milling device.

The bamboo parts which are used as raw material for the present invention may in particular be bamboo chips having a longest dimension in a range of 5-50 mm. The bamboo parts are typically parts of culms because these provide the strongest fibers.

In some embodiments, the system further comprises at least one length sieve device positioned downstream from the at least one diameter sieve device and configured for receiving bamboo fibers which have been sieved by the at least one diameter sieve device, wherein the at least one length sieve device is configured for separating the received bamboo fibers in at least a first length fraction of relatively short bamboo fibers and a second length fraction of relatively long bamboo fibers, wherein the bamboo fibers of the second length fraction have a greater length than the bamboo fibers of the first length fraction.

It was found that different length fractions have different characteristics and that it is advantageous to obtain fractions having not only a specific diameter but also a specific length or length range. Bamboo fibers having a high aspect ratio of length/diameter tend to become entangled which was found to be advantageous when making products such as sheet material. Therefore, a fraction having a relatively great length/diameter ratio may result in a strong product such as a sheet material.

Further, it was recognized in the present invention that one reason for the higher quality is that the bamboo fibers may be produced in one location and processed into products in another location. The bamboo fibers would then typically be transported in bags or containers, each bag or container containing a substantial volume and weight of bamboo fibers. However, if such a bag or container contains bamboo fibers of different sizes, the bamboo fibers of larger size will tend to move upward relative to the bamboo fibers of smaller size during transport as a result of granular convection. When the bag or container is then unloaded, the volume of bamboo fibers has a size gradient over the height thereof. This makes it difficult to manufacture products with a specified size of bamboo fibers, because the size of the bamboo fibers will gradually decrease, starting from the top and going to the bottom of the bag or container. This poses a serious problem for certain production processes. It was found in the present invention that this effect applies not only to the diameter of the bamboo fibers, but also to the length. Therefore, separating bamboo fibers both in diameter fractions and length fractions allows a higher quality production of products made of bamboo fibers.

In some embodiments, the at least one milling device comprises:
an upper milling disc, in particular an upper millstone, the upper milling disc having at least one entry opening,
a lower milling disc, in particular a lower millstone, and
a milling drive,
the upper milling disc being positioned above the lower milling disc, wherein the milling drive is configured to rotate at least one of the milling discs about a vertical axis (56).

It was found that milling discs which are rotary about a vertical axis create fibers without breaking the fibers. The discs open the bamboo parts with friction rather than breaking the bamboo parts. This results in bamboo fibers having a greater average length, which ultimately results in stronger products. Also, the parenchyma is loosened by the milling discs due to the same friction force. This is also advantageous.

The system may comprise between three sets and ten sets, in particular at least four sets, which are placed in series and interconnected by a respective feed trajectory. The diameter sieve devices of multiple sets may have a same size of the diameter sieve openings and a same threshold diameter. The threshold diameter may be between 200 and 600 μm, in particular 400 μm.

In some embodiments, the system comprises a merge trajectory, in particular formed by at least one merge conveyor having multiple entry openings, wherein the fractions of relatively narrow bamboo fibers which are discharged via the respective narrow diameter exits of the diameter sieve devices are entered into the merge trajectory via an entry opening in order to be merged into a merged fraction of relatively narrow bamboo fibers. In this way, the bamboo fibers of a specific width range which are created in each set are advantageously merged into a (single) stream.

In some embodiments, the system comprises a further diameter sieve device configured for receiving the merged fraction of relatively narrow bamboo fibers from the merge trajectory and for separating the merged fraction of relatively narrow bamboo fibers into at least a first width fraction of relatively narrow bamboo fibers and a second width fraction of relatively wide bamboo fibers, and in particular into at least three separate width fractions. It was found that this configuration combines the advantages that 1) a high portion by weight of the incoming bamboo parts is converted into bamboo fibers in the desired diameter range and 2) that diameter fractions are obtained which are well defined by diameter. The system may also comprise more than one further diameter sieve if more width fractions are desired. Also, a single further diameter sieve with more sieve decks may be used to obtain more width fractions.

The at least one length sieve device may be configured for receiving the merged fraction of relatively narrow bamboo fibers.

In some embodiments, the at least one length sieve device may be positioned downstream from the further diameter sieve device and configured for receiving a width fraction, in particular the first or second width fraction, which is discharged from the further diameter sieve device.

In some embodiments, the system may comprise a length subsystem comprising at least the first length sieve device and a second length sieve device, the first and second length sieve device being positioned downstream from the further diameter sieve device,
wherein the first length sieve device receives the first width fraction and further separates the first width fraction into at least a first length fraction of relatively long bamboo fibers and a second length fraction of relatively short bamboo fibers,
wherein the second length sieve device receives the second width fraction and further separates the second width fraction into at least a third length fraction of relatively long bamboo fibers and a fourth length fraction of relatively short bamboo fibers.

Advantageously, at least four fractions are obtained wherein each fraction has a specific and different combination of a width range and length range. More fractions can be obtained with more length sieves if desired.

A method of manufacturing bamboo fibers from bamboo parts comprises:
supplying bamboo parts to the system according to any of the preceding claims,
milling the bamboo parts into bamboo fibers with the at least one milling device of the first set,
sieving the formed bamboo fibers with the at least one diameter sieve device of the first set, thereby separating the bamboo fibers in the first width fraction of relatively narrow bamboo fibers and the second width fraction of relatively wide bamboo fibers,
discharging the relatively narrow bamboo fibers which have passed the diameter sieve of the first set via the narrow diameter exit of the first set,
feeding the relatively wide bamboo fibers which are discharged from the wide diameter exit of the first set to the milling device of the second set via a feed trajectory (26) which extends from the diameter sieve device of the first set to the milling device of the second set,
wherein a total flow of bamboo fibers which is passed on from one set to the next set decreases with each set.

The method provides the same advantages as the device according to the intention.

In some embodiments, the method comprises merging the fractions of relatively narrow bamboo fibers which are discharged via the respective narrow diameter exits of the different diameter sieve devices into a merged fraction of bamboo fibers which follows the merge trajectory, wherein a total flow of bamboo fibers which follows the merge trajectory increases with each set.

In some embodiments, the merged fraction of relatively narrow bamboo fibers is fed to the further diameter sieve device, wherein the further diameter sieve device separates the merged fraction of relatively narrow bamboo fibers into at least a first width fraction of relatively narrow bamboo fibers and a second width fraction of relatively wide bamboo fibers.

In some embodiments, the method comprises feeding the first or second width fraction which is discharged from the further diameter sieve device to the at least one length sieve device and separating the bamboo fibers in at least a first length fraction of relatively long bamboo fibers and a second length fraction of relatively short bamboo fibers with the length sieve device.

In some embodiments, the bamboo parts which are used as raw material are bamboo chips and have a longest dimension in a range of 5-50 mm, more in particular 15-45 mm. It was found that this is a suitable base material for creating the desired fractions.

In some embodiments the bamboo fibers are separated in at least:
a first fraction having a diameter in a range of 0-100 μm but not a specified length,
a second fraction having a diameter in a range of 100-200 μm, and a length in a range of 1-2 mm,
a third fraction having a diameter in a range of 100-200 μm, and a length in a range of 2-4 mm,
a fourth fraction having a diameter in a range of 100-200 μm, and a length in a range of 4-15,
a fifth fraction having a diameter in a range of 200-400 μm, and a length in a range of 1-3 mm,
a sixth fraction having a diameter in a range of 200-400 μm, and a length in a range of 3-6 mm,
a seventh fraction having a diameter in a range of 200-400 μm, and a length in a range of 5-15 mm, and
an eighth fraction having a diameter in a range of 400-1000 μm, and a length in a range of 7-30 mm.

It was found that these fractions provide a good starting point for making various products from the bamoo fibers.

In some embodiments, the milling process and the sieving process(es) are dry in that the bamboo parts which are used as raw material are dry and no liquid is added to the bamboo fibers during the processing of the bamboo parts. In this way, the strength of the bamboo fibers is not compromised.

In some embodiments the bamboo parts are parts of the culm. Culm provides the strongest bamboo fibers.

Bamboo leaves are typically not used or only used to a minor extent, because leaves do not result in strong bamboo fibers.

### Device and Method for Manufacturing Sheet Material

In a second, independent aspect, the present invention relates to a device for manufacturing a sheet material comprising bamboo fibers, the device comprising:
a film material conveying system comprising:
   a spool holder for holding a spool comprising a film material, and
   a film material conveyor comprising one or more guides for transporting the film material along a deposition area,
a bamboo fiber deposit station for depositing a first layer of bamboo fibers, the bamboo fiber deposit station comprising:
   at least one hopper configured for holding bamboo fibers, the hopper comprising a hopper exit at a lower side thereof,
   a movable distributor member, in particular a distributor sieve, comprising multiple distributor openings, the movable distributor member configured for receiving bamboo fibers from the hopper,
   a distributor drive configured for vibrating the distributor member in order to let the bamboo fibers pass the distributor openings and in order to scatter the bamboo fibers evenly as a layer over the film material in the deposition area, wherein the layer has a uniform thickness and wherein the bamboo fibers have a uniformly distributed direction, and
a heating device positioned along the film material conveyor downstream from the deposition area, wherein the heating device is configured for heating the film material, thereby connecting the bamboo fibers to the film material and forming the sheet material, and
a pressing device for pressing the heated film material and bamboo fibers onto one another.

The sheet material can be used for various flat purposes and also for 3d shaped products. The device can in particular use the bamboo fibers obtained with the system according to the present invention as raw material.

In some embodiments, the movable distributor member is positioned directly below the hopper exit and configured for receiving bamboo fibers which drop from the hopper exit.

In some embodiments, the distributor drive is configured for moving the distributor member in an oscillating movement. Advantageously, an even distribution of the bamboo fibers can be obtained.

In some embodiments, the device comprises:
a first roller positioned in the hopper, wherein the first roller comprises projections,
a first roller drive configured for rotating the first roller about a first horizontal rotation axis.

In some embodiments, the projections are elongate and extend radially, wherein the projections are in particular spikes.

In some embodiments, the device comprises:
a second roller positioned in the hopper,
a second roller drive or common drive configured for rotating the second roller about a second horizontal rotation axis,
wherein the first and second roller define a roller gap between them, and wherein the first and second roller are rotated in a same direction, wherein a part of the first roller which is located at the gap moves in an opposite direction as a part of the second roller which is located at the opposite side of the gap.

Bamboo fibers are relatively difficult to distribute evenly and this embodiment improves the ven distribution.

In some embodiments, the second roller is positioned diagonally above the first roller. This further improves the evenness of the distribution.

In some embodiments the device comprises a dispersing assembly which is positioned upstream from the at least one hopper in particular upstream from the first and second serial hopper, wherein the dispersing assembly comprises:
a dispersing hopper,
a first set of a first conveyor belt and a second conveyor belt positioned at an exit of the dispersing hopper where the bamboo fibers exit the dispersing hopper, wherein the first and second conveyor belt convey the bamboo fibers from the dispersing hopper and create a steady flow of bamboo fibers having a horizontal component of movement, wherein the first conveyor belt is positioned above the second conveyor belt to create a passage between them,
a first rotatable distributor brush provided at the downstream end of the first set of conveyor belts, wherein the first rotatable distributor brush spreads out the flow of bamboo fibers and creates a thinner flow of bamboo fibers, the first rotatable distributor brush being positioned upstream of the at least one hopper.

It was found in the present invention that the bamboo fibers are difficult to distribute evenly in a well controlled flow and this embodiment significantly improves the distribution of the bamboo fibers.

In the second aspect, a method of manufacturing a sheet material comprising bamboo fibers comprises:
loading the hopper of the device according to the invention with bamboo fibers,
conveying the film material along the deposition area,
depositing bamboo fibers as a layer onto the film material in a scattered manner, and
heating the film material in the heating device and connecting the bamboo fibers to the film material.

In the second aspect the invention further relates to sheet material comprising bamboo fibers and a thermoplastic material which interconnects the bamboo fibers. Advantageously, the sheet material can be used in a wide variety of applications.

In some embodiments of the sheet material, the bamboo fibers form one or more fractions, wherein each fraction is defined by a range of lengths and by a range of diameters. This advantageously provides a homogenous well controlled quality of the sheet material.

### SHORT DESCRIPTION OF THE FIGURES

Embodiments of the system and the method will be described by way of example only, with reference to the accompanying schematic drawings in which corresponding reference symbols indicate corresponding parts, and in which:

FIG. 1A shows a diagrammatic view of a first part of the system of the present invention.

FIG. 1B is an enlarged version of FIG. 1A, with some parts left out.

FIG. 2 shows a diagrammatic view of a second part of the system of the present invention.

FIG. 3 shows an arrangement of multiple sets according to the present invention.

FIG. 4 shows a sectional side view of a milling device according to the present invention.

FIGS. 5-8 show various views of a diameter sieve device according to the present invention.

FIG. 9 shows a side view of a further diameter sieve device according to the present invention.

FIGS. 10-13 show sectional top views of embodiments of the further diameter see device of FIG. 9.

FIG. 14 shows a side view of a length sieve device according to the present invention.

FIG. 15 shows an isometric view of a length sieve device according to the present invention.

FIG. 16 shows the same view as FIG. 15 with the upper part of the length sieve device left out.

FIGS. 17A-17F and FIGS. 18A-18F show embodiments of the length sieve in top view.

FIGS. 19A-19F and FIGS. 20A-20F show further embodiments of the length sieve in top view.

FIG. 21 shows a diagrammatic overview of a device and method for manufacturing sheet material according to the present invention.

FIG. 22 shows a schematic side view of the device for manufacturing sheet material according to the present invention.

FIG. 23 shows an isometric view of the device shown in FIG. 22.

FIG. 24 shows a schematic side view of another embodiment of the device for manufacturing sheet material according to the present invention.

FIGS. 25, 26 and 27 show respectively a front, rear and isometric view of the hopper according to the present invention.

FIGS. 28, 29, 30, 31, 32 and 33 show embodiments of the sheet material according to the present invention.

FIG. 34 shows another embodiment of a hopper assembly according to the present invention.

### DETAILED DESCRIPTION OF THE FIGURES

Turning to FIGS. 1A, 1B and 2, which are best interpreted in conjunction, the system 10 according to the present invention is shown. A part of the system 10 is shown in FIG. 1 and a part of the system is shown in FIG. 2. The system 10 comprises a diameter subsystem 6 and a length subsystem 8. The diameter subsystem 6 is configured for creating bamboo fibers and (intermediate) products from the bamboo parts and separating the bamboo fibers in suitable width fractions for further processing by the length subsystem 8.

The diameter subsystem 6 of the system 10 comprises a hopper 13 with which raw material in the form of bamboo parts 205, in particular bamboo chips, are fed to the system. The diameter subsystem 6 comprises at least one milling device 12 configured for milling the bamboo parts into bamboo fibers. In this embodiment the system comprises four milling devices 12.

The diameter subsystem 6 further comprises at least one diameter sieve device 18 configured for separating the bamboo fibers in a first width fraction 20 of relatively narrow bamboo fibers and a second width fraction 21 of relatively wide bamboo fibers, wherein the bamboo fibers of the second width fraction have a greater diameter than the bamboo fibers of the first width fraction.

Each diameter sieve device 18 (individually numbered as 18.1-18.4 and commonly denoted as 18) comprises at least one narrow diameter exit 31 via which the relatively narrow bamboo fibers which have passed the diameter sieve are discharged from the diameter sieve device and at least one wide diameter exit 32 via which the relatively wide bamboo fibers which have not passed the diameter sieve are discharged from the diameter sieve device 18.

The milling devices 12 and diameter sieve devices 18 are arranged in sets (or pairs). The diameter subsystem 6 comprises at least a first set 25.1 and a second set 25.2 placed in series. Each set comprises:
at least one milling device 12, and
at least one diameter sieve device 18 configured to receive bamboo fibers from the milling device of the same set.

The diameter subsystem 6 comprises a number of feed trajectories 26 which extend from the diameter sieve device of the first set to the milling device of the second set, for feeding the fraction of relatively wide bamboo fibers which are discharged from the wide diameter exit 32 of the first set to the milling device of the second set. Here, the diameter subsystem 6 comprises four sets 25.1-25.4, but a different number is possible, for instance between three sets and ten sets. The sets are placed in series and interconnected by a respective feed trajectory 26.1-26.4.

The diameter sieve devices 18 of multiple sets 25.1-25.4 have a same size of the diameter sieve openings and a same threshold diameter. The threshold diameter of the diameter sieve devices may be between 200 and 600 μm and may in particular be 400 μm.

The diameter subsystem 6 comprises a merge trajectory 28 having multiple entry openings 30. The merge trajectory may be formed by at least one merge conveyor or by a drop chute. The fractions of relatively narrow bamboo fibers which are discharged via the respective narrow diameter exits 31 of the diameter sieve devices 18 are entered into the merge trajectory 28 via the entry opening 30 in order to be merged into a merged fraction of relatively narrow bamboo fibers. The merge trajectory may comprise a collector hopper 29. The flow of bamboo fibers in the merge trajectory increases with each set because at each set a flow of bamboo fibers is added.

Because at each diameter sieve device a portion of the incoming flow of bamboo fibers is discharged via the narrow diameter exit 31, the portion of the flow which is passed on to the next set 25 decreases with each set. At the fourth set 25.4, the incoming flow of bamboo fibers is considerably smaller than at the first set 25.1.

The diameter subsystem 6 comprises at least one return flow trajectory 351 extending from a downstream diameter sieve device 18.4 to at least one milling device 12 positioned further upstream, for returning a fraction of relatively wide bamboo fibers which have not passed the diameter sieve of the downstream diameter sieve device 18.5 to the milling device positioned further upstream for re-processing the fraction.

The diameter sieve device 18.4 of the most downstream set 25.4 comprises two diameter sieves 70.1, 70.2 positioned above one another. The fraction of bamboo fibers which does not pass the upper diameter sieve 70.1 enters the return flow trajectory 351. The fraction of bamboo fibers which passes the upper diameter sieve 70.1 but not the lower diameter sieve 70.2 is fed to a downstream diameter sieve device 18.5. The fraction which passes both diameter sieves 70.1, 70.2 enters the merge trajectory 351.

The downstream diameter sieve device 18.5 separates the incoming fraction which has a diameter smaller than 1000 μm in two fractions, one fraction having a diameter of 400-1000 μm which is stored in a collector container 44 and one fraction having a diameter greater than 1000 μm which is fed into the merge trajectory 351.

The downstream diameter sieve device 12.5 has another exit 31 via which bamboo fibers of a relatively large width are discharged, e.g. bamboo fibers having a diameter of between 400 and 1000 μm. This fraction is not further processed in the length subsystem 8, but collected in a container 44 and used as reinforcement material in various applications.

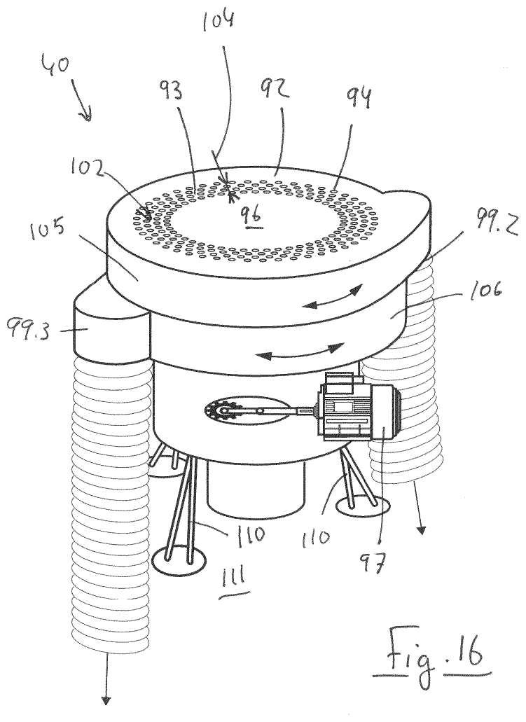

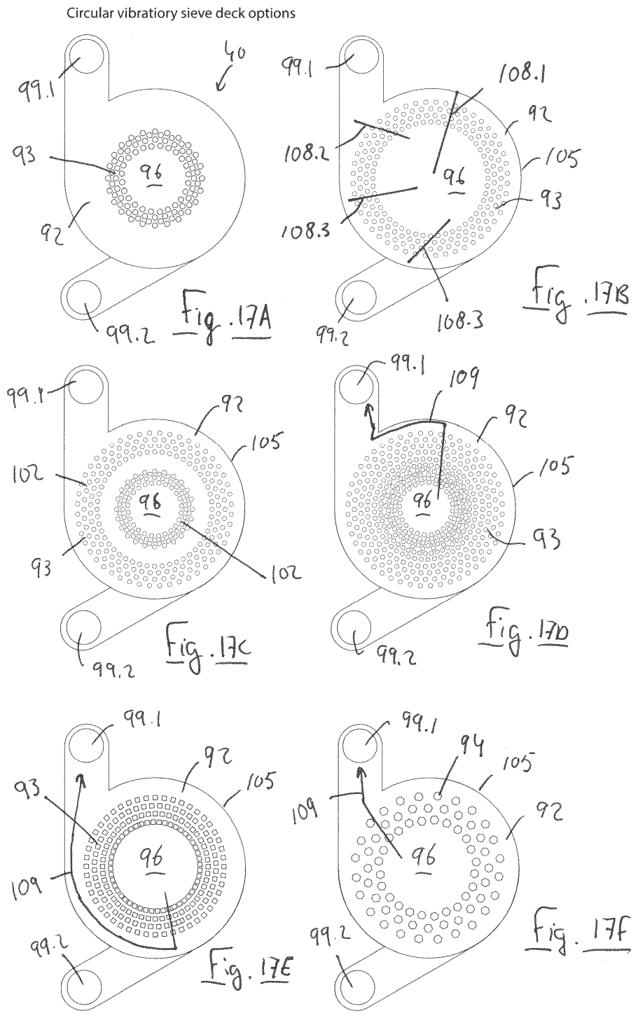

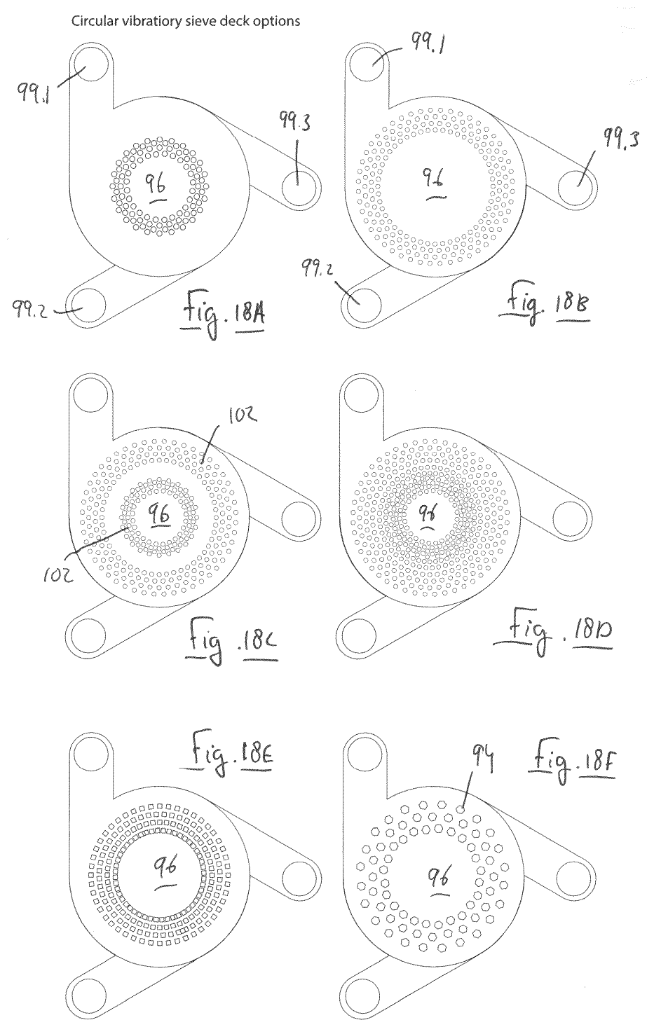

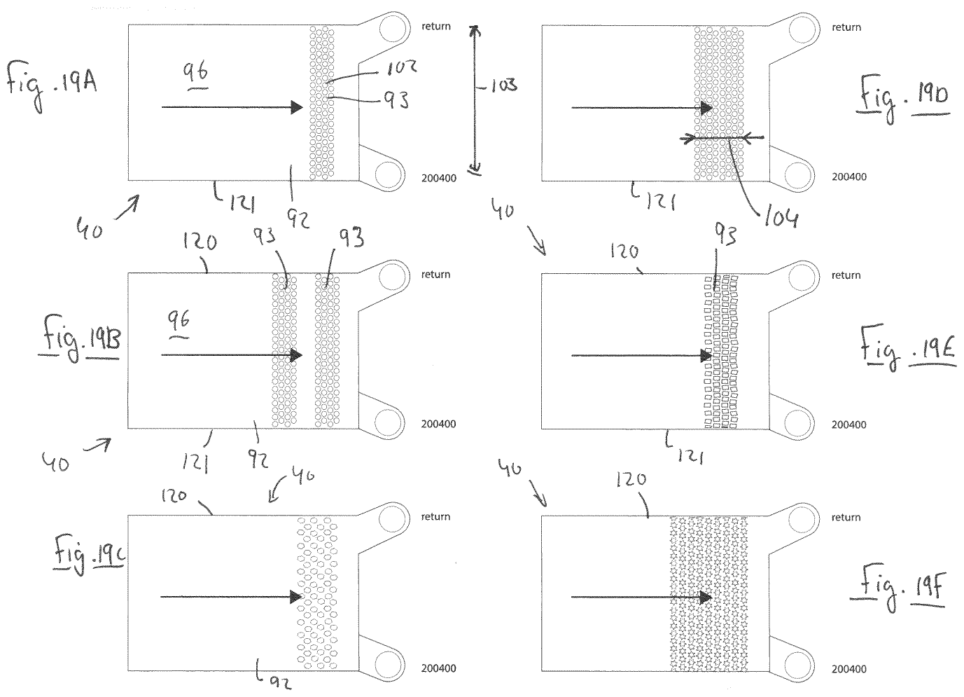

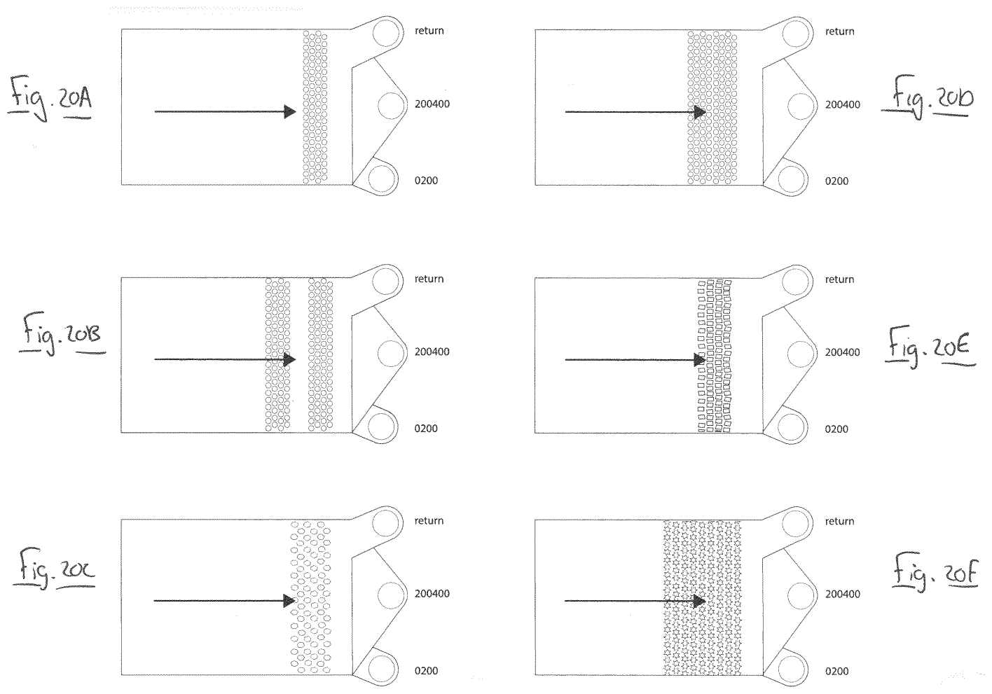

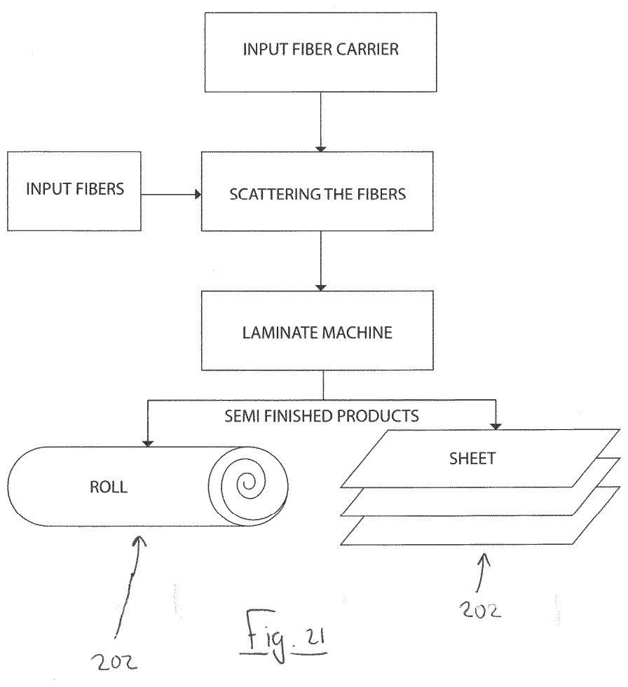

Turning to FIG. 2, in the shown embodiment, the diameter subsystem 6 comprises a further diameter sieve device 34 configured for receiving the merged fraction of relatively narrow bamboo fibers 204 from the merge trajectory 28, in this embodiment via a hopper 37. In FIG. 2 the bamboo fibers are drawn in enlarged form in the hopper 37. A controlled dosing device 341 is provided for controllably feeding the bamboo fibers to the further diameter sieve device 34 from the hopper 37. The further diameter sieve device 34 comprises two diameter sieves 70.1, 70.2 placed above one another. The upper diameter sieve 70.1 has larger openings than the lower diameter sieve 70.2. The further diameter sieve 34 is configured to separate the merged fraction of relatively narrow bamboo fibers into at least a first width fraction 35 of relatively narrow bamboo fibers and a second width fraction 36 of relatively wide bamboo fibers, and in particular into three separate width fractions 35, 36, 37. In this embodiment, the upper exit 32 discharges a width fraction 37 having a diameter range of 200-400 μm, but a different range is possible. The next exit 31 discharges a fraction 36 of bamboo fibers having a diameter range of 100-200 μm, but a different range is possible. The lowest exit 33 discharges a fraction 35 of bamboo fibers having a diameter in the range of 0-100 μm, but a different range is possible. The fraction 35 is essentially dust and not processed further. Turning to the embodiment of FIG. 9, the further diameter sieve device 34 comprises three diameter sieves 70.1, 70.2, 70.3 placed above one another and comprises four exits 31-33 and 134. In this embodiment, the further diameter sieve device is configured to discharge four fractions of bamboo fibers having four different ranges in diameter. The further diameter sieve device 34 forms the last stage of the diameter subsystem 6. The length subsystem 8 starts downstream from the diameter sieve device 34.

The length subsystem 8 of the system 10 comprises at least one length sieve device. The at least one length sieve device 40 is positioned downstream from the diameter subsystem and in particular positioned downstream from the diameter sieve devices 18.1-18.4, 34 and configured for receiving bamboo fibers from the at least one diameter sieve device. Here, the length subsystem 8 comprises two length sieve devices 40.1 and 40.2, but a different number is possible. Each length sieve devices receive bamboo fibers from one of the exits 31, 32, 33 of the further diameter sieve device 34. The first length sieve device 40.1 receives the width fraction 36 of 100-200 μm diameter and the second length sieve device 40.2 receives the width fraction 37 of 200-400 μm diameter.

The first length sieve device 40.1 is configured for separating the received width fraction 36 of bamboo fibers in at least a first length fraction 41.1 of relatively short bamboo fibers having a length of 1-2 mm and a second length fraction 41.2 of relatively long bamboo fibers having a length of 2-4 mm, and a third length fraction 41.3 having a length of 4-15 mm. The bamboo fibers of the third length fraction have a greater length than the bamboo fibers of the second length fraction, which in turn have a greater length than the bamboo fibers of the first length fraction. The first length sieve device 40.1 comprises two length sieves positioned above one another as will be explained further below.

The second length sieve device 40.2 separates the width fraction 37 into at least a third length fraction of relatively long bamboo fibers and a fourth length fraction of relatively short bamboo fibers, but may separate the received width fraction in more length fractions. In this embodiment, the second length sieve device 40.2 separates the incoming width fraction 37 of bamboo fibers in three length fractions 42.1, 42.2, 42.3, having length ranges of respectively 1-3 mm, 3-6 mm and 6-15 mm. Different ranges are possible.

Turning to FIG. 3, the sets 25 may be positioned vertically above one another so that gravity assists the flow of bamboo fibers from one set to the next set. In other embodiments a set may comprise multiple devices placed in parallel and/or multiple diameter sieve devices placed in parallel. Also, a set 25 may have a different number of milling devices than diameter sieve devices.

### Aspects of Milling Device

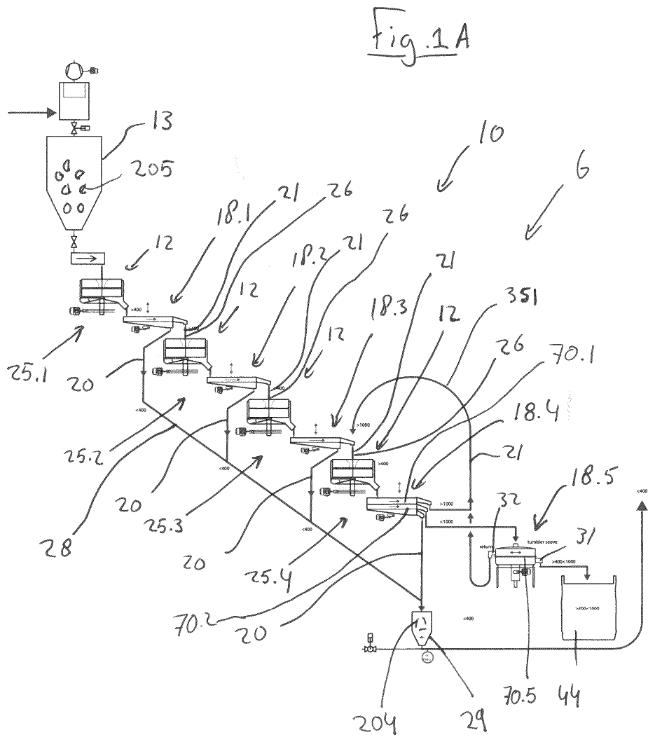

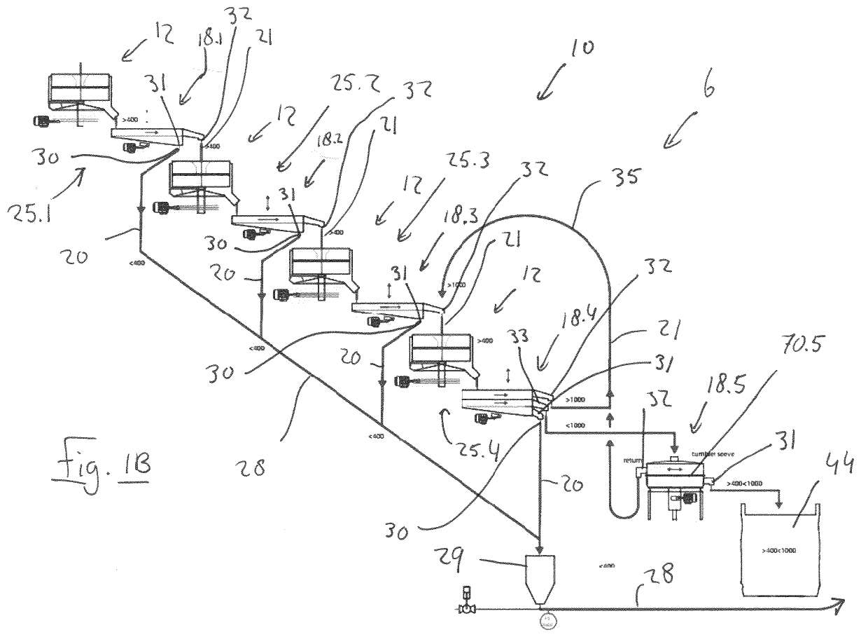

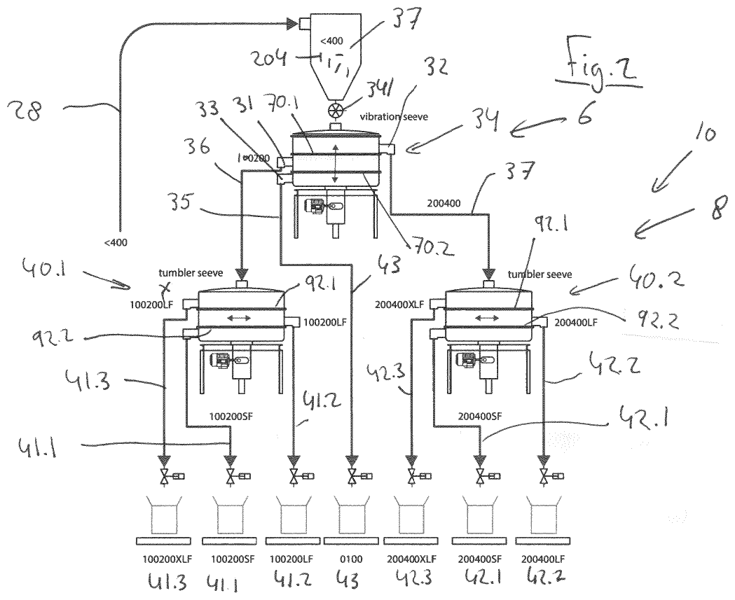

Turning to FIG. 4, each milling device 12 comprises an upper milling disc 50, in particular an upper millstone, the upper milling disc having at least one entry opening 51. Each milling device further comprises a lower milling disc 52, in particular a lower millstone. The upper milling disc is positioned above the lower milling disc. A milling gap 54 is defined between the milling discs. Each milling device further comprises a milling drive 55, wherein the milling drive is configured to rotate at least one of the milling discs about a vertical axis 56 via a shaft 155. Each milling device has a milling exit 58 via which the bamboo fibers are discharged. The milling gap 54 is horizontal. The milling discs 50, 52 may have grooves on the sides of the gap.

Each milling device further comprises a cooling system 57 which comprises a pump and a closed circuit 59 for a cooling fluid. The closed circuit comprises channels 159 extending through the milling discs. Each milling device 12 further comprises an air ventilation system 67 at the entry opening 51 and at the exit to extract dust and parenchyma. This improves the quality of the end product. A rotary brush or sweeping plate 53 is provided to brush or sweep the milled bamboo fibers to the exit 58. The entry opening 51 is closed off with plates 151 to peek all material inside and prevent dust from escaping the milling device. A housing 152 extends around the milling discs to keep the material inside and prevent dust from spreading. The shaft 155 extends through an opening in a bottom wall 153 of the housing.

Each milling device further comprises a milling control unit 100, a torque sensor 101 which measures a parameter representative of a load on the milling device, in particular a torque between the milling discs, and a controllable supply device 60 comprising a hopper 61 and a controllable valve 62 which is controlled by actuator 63. The milling control unit is configured to control the supply of bamboo fibers through the diameter sieve entry on the basis of a measured torque. If the torque becomes too high, the supply of bamboo fibers is reduced. If the torque becomes too low, the supply of bamboo fibers is increased.

The milling discs effectively mill the incoming bamboo parts into bamboo fibers and do this better than known grinders which use hammers or rollers. The outgoing stream of material contains relatively few bamboo parts having a different shape than a fibrous shape. Spherical or bulky bamboo parts do not pass the milling discs without being converted to fibres, for the most part.

### Aspects of Diameter Sieve Device

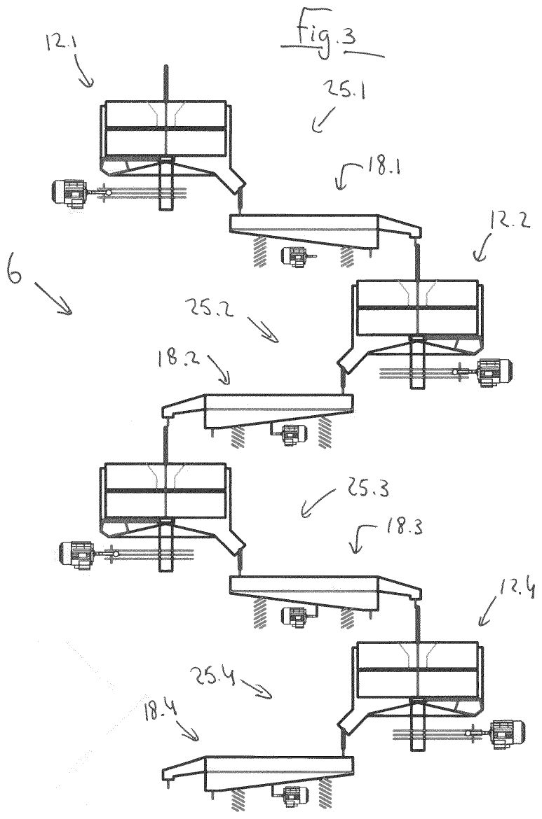

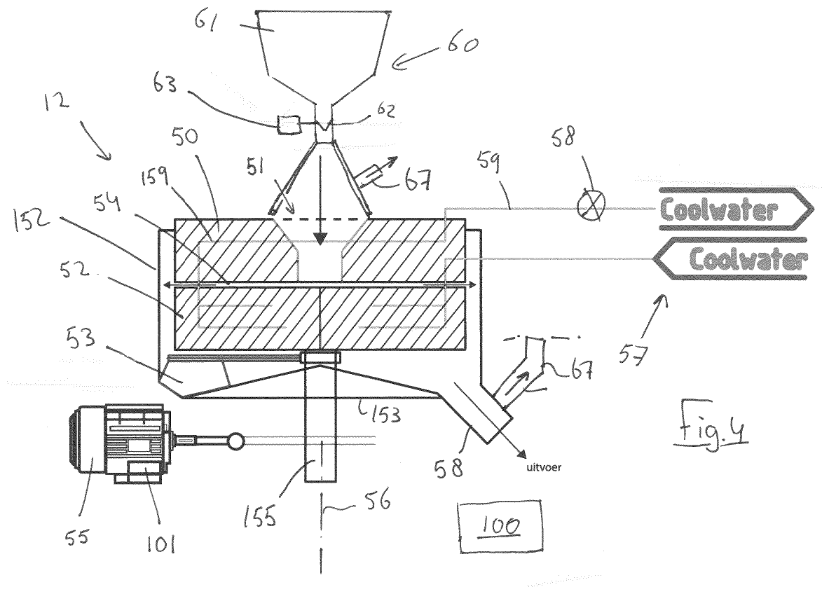

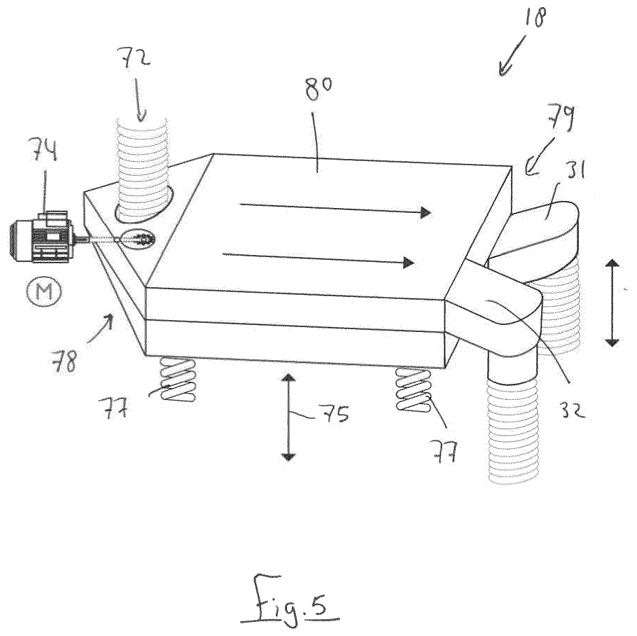

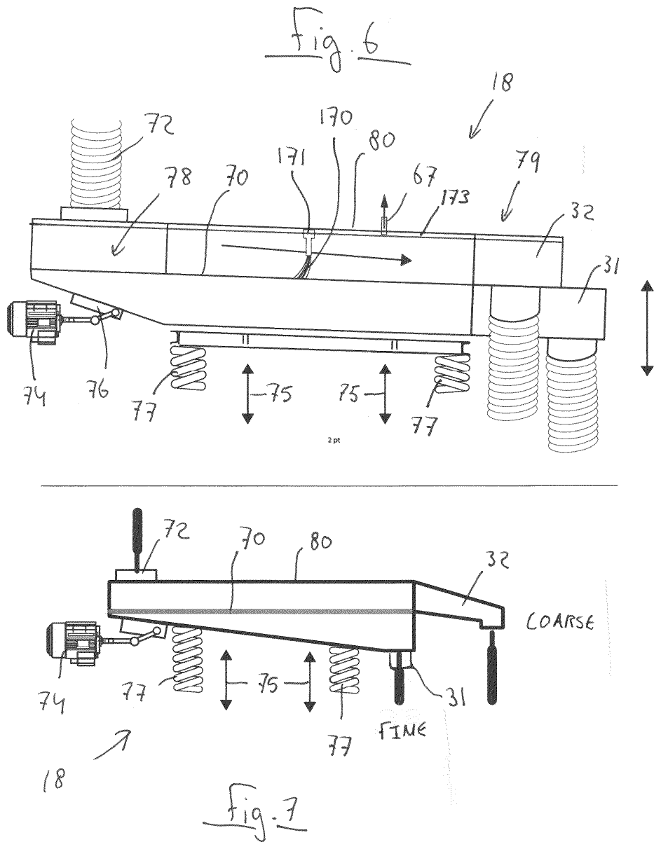

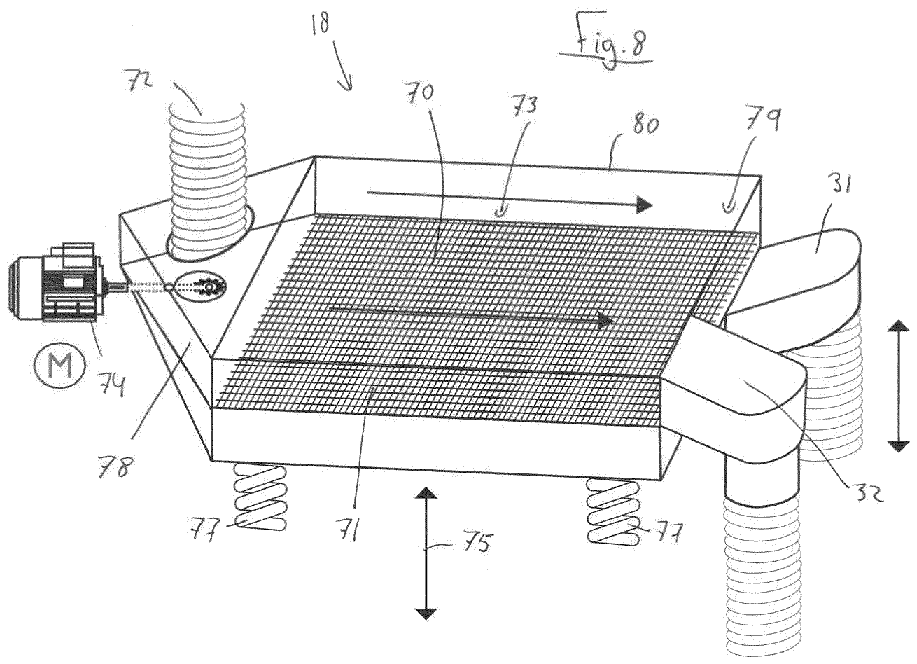

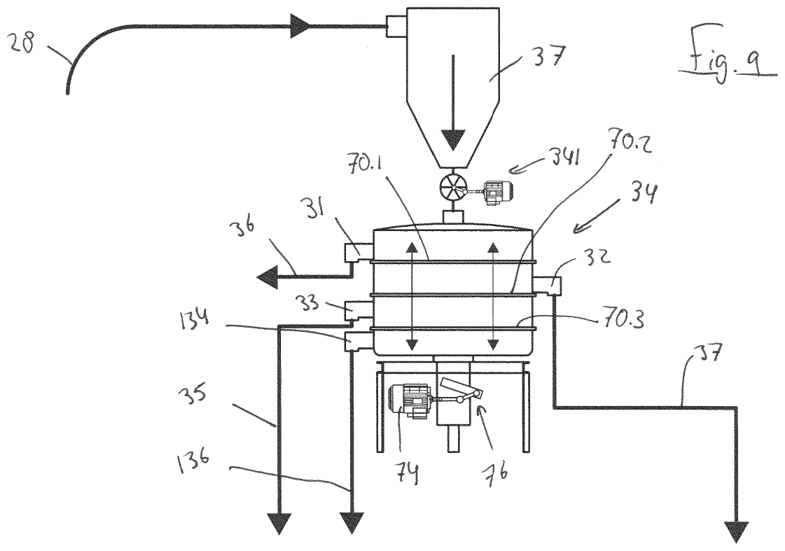

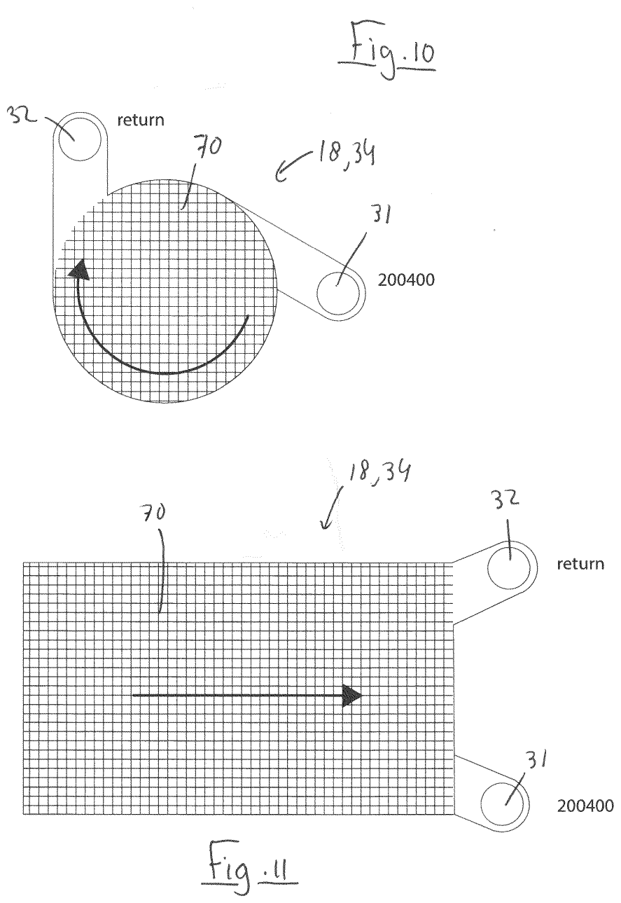

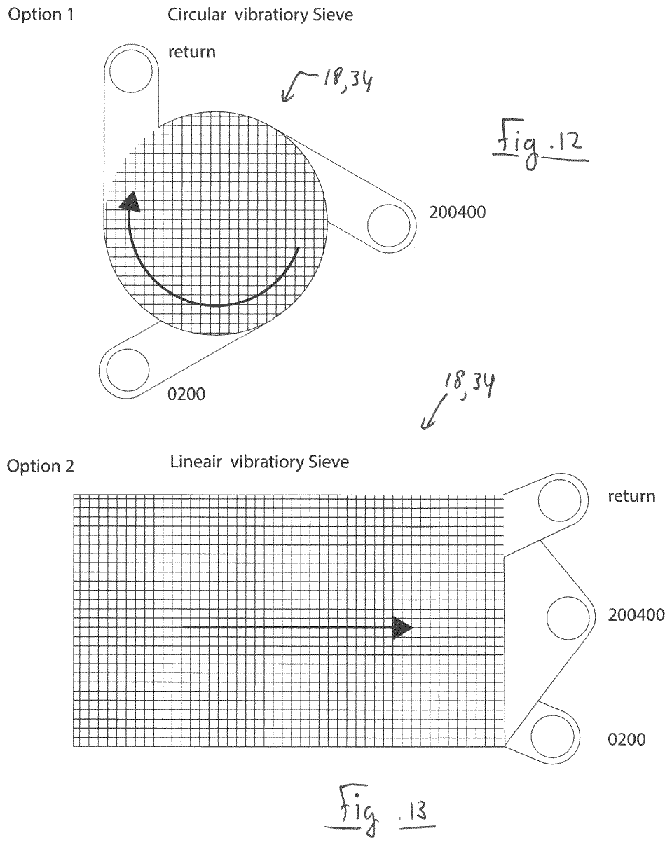

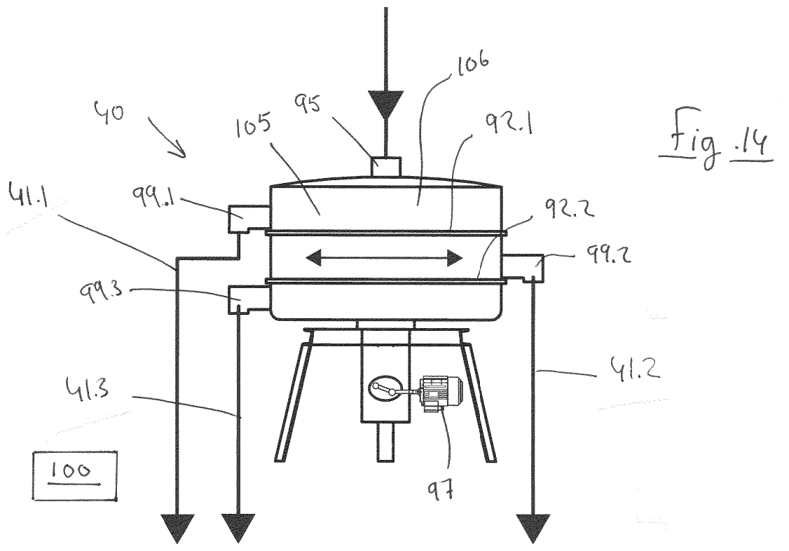

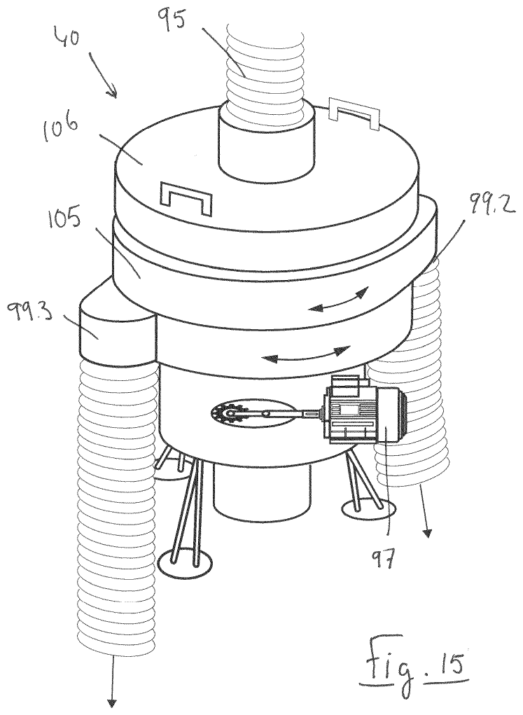

Turning to FIGS. 5-8, each diameter sieve device 18 comprises a housing 80 and a diameter sieve 70 comprising multiple diameter sieve openings 71 having a size which determines a threshold diameter. The openings 71 may be arranged in a grid.

Each diameter sieve device 18 comprises a diameter sieve entry 72 via which the bamboo fibers enter the diameter sieve device and subsequently engage an upper side 73 of the diameter sieve. Each diameter sieve device 18 comprises a diameter sieve drive 74 configured for vibrating the diameter sieve 70 over a vertical distance 75 in order to let at least a portion of the bamboo fibers become airborne, in order to reorient the bamboo fibers to a vertical or substantially vertical orientation. The diameter sieve drive 74 is configured for each time abruptly moving the diameter sieve in a vertical direction, in particular in an upward direction, wherein the bamboo fibers which lie on the upper side of the diameter sieve become airborne as a result of the abrupt movement. To this end, the diameter sieve drive 74 comprises one or more hitting members 76 which are constructed to repeatedly hit the diameter sieve from below. Other arrangements are also possible.

The diameter sieve is supported by flexible members 77 such as springs which allow the vibration.

In operation, the bamboo fibers having a diameter smaller than the threshold diameter pass the diameter sieve through the diameter sieve openings 71. The bamboo fibers having a diameter larger than the threshold diameter do not pass the sieve but remain on the upper side of the diameter sieve 70.

A width of the diameter sieve openings 71 of the diameter sieve device 18 is in a range of 300-2000 μm, in particular 300-1500 μm, resulting in a same threshold diameter.

In the shown embodiment, the diameter sieve device comprises a supply end 78 and a discharge end 79 provided on opposite ends of the diameter sieve, wherein when seen in top view the diameter sieve entry is located on the supply end and the narrow and wide diameter exits are located on the discharge end. The diameter sieve drive is configured for moving the bamboo fibers from the supply end 78 in the direction of the discharge end 79. The diameter sieve 70 may be inclined, wherein the discharge end 79 is lower than the supply end 78. When seen in top view the diameter sieve device 18 has a rectangular or square shape.

In the shown embodiment, the diameter sieve device is formed by a mesh 81, in particular a wire mesh. When seen in top view the diameter sieve openings 71 in particular have a polygonal shape, more in particular a rectangular, square or diamond shape. The wire which forms the mesh has a circular cross section. This shape provides guidance to bamboo fibers which, after becoming airborne, are oriented vertically or substantially vertically so that one end of the fiber points downward, but which are not fully aligned with an opening 71. The lower end of the bamboo fiber may graze the wire and subsequently enter the opening 71.

Turning to FIG. 6, the diameter sieve device 18 may further comprise:
a sieve brush 170, and
a brush drive 171,
   wherein the brush drive is configured to move the brush over the diameter sieve toward the at least one wide diameter exit 32 in order to move the bamboo fibers which have not passed the diameter sieve to the at least one wide diameter exit. In this embodiment, a rail 173 is provided and the brush drive 171 is a traveller which runs along the rail 173.

Each diameter sieve device may comprise an air ventilation 67 to remove dust, which may comprise parenchyma. The air ventilation 67 may comprise a filter and a container to catch the dust. Removal of parenchyma results in a higher quality of the resulting fractions of bamboo fibers.

Turning to FIG. 10, in another embodiment, the diameter sieve 18 or further diameter sieve 34 may have a round shape when seen in top view, and wherein the narrow diameter exit is provided at the circumference of the diameter sieve, and wherein when seen in top view the diameter sieve has a round shape, wherein the diameter sieve entry is located centrally, wherein the diameter sieve drive is configured for moving the bamboo fibers outwardly, away from the center.

Turning to FIG. 11 another embodiment of the diameter sieve 18 or further diameter sieve 34 is shown.

Turning to FIGS. 12 and 13, the diameter sieve 18 and/or further diameter sieve 34 may also have three exits and in this embodiment the diameter sieve 18 and/or further diameter sieve 34 comprises two diameter sieves 70 (also indicated as 70.1 and 70.2) arranged in a stack. A lower diameter sieve 70 has smaller openings than an upper diameter sieve.

### Aspects of Length Sieve Device

Turning to FIGS. 14-16, the at least one length sieve device 40 is configured for receiving relatively narrow bamboo fibers from the diameter subsystem 6 and in particular from the further diameter sieve device 34. The at least one length sieve device 40 is positioned downstream from the further diameter sieve device 34 and configured for receiving the first or second width fraction which is discharged from the further diameter sieve device.

The at least one length sieve device 40 comprises:
at least one length sieve 92.1, 92.2 (commonly indicated as 92) comprising an openings area 93 which comprises multiple length sieve openings 94, and
a length sieve entry 95 located at an upstream side of the openings area, wherein bamboo fibers which enter the length sieve via the length sieve entry are deposited on a deposition zone 96 on the at least one length sieve,
a length sieve drive 97 configured for vibrating the length sieve over a horizontal distance 98 in order to move the bamboo fibers from the deposition zone over the length sieve and across the openings area, wherein relatively short bamboo fibers drop through the length sieve openings and wherein relatively long bamboo fibers travel across the length sieve openings without dropping through the length sieve openings,
a long fiber exit 99.1 via which the first length fraction 41.1 of relatively long bamboo fibers which have travelled across the openings area is discharged from the length sieve device, and
a short fiber exit 99.2 via which the second length fraction 41.2 of relatively short bamboo fibers which have dropped through the length sieve openings are discharged from the length sieve device.

The length sieve 92 is a metal plate and the multiple length sieve openings are formed in the plate. The openings area has the shape of at least one band 102 having a band length 103 and a band width 104. The length sieve drive 97 is configured to move the bamboo fibers across the band-shaped openings area.

The length sieve 40 shown in FIGS. 14-16 comprises at least an upper length sieve 92.1 having an upper long fiber exit 99.1 and a lower length sieve 92.2 having a lower long fiber exit 99.2 which are mounted in a common housing 106. The upper length sieve 92.1 is positioned above the lower length sieve 92.2. The lower length sieve comprises length sieve openings 94 which are smaller than the length sieve openings 94 of the upper length sieve. The length sieve device comprising at least three exits:
an extra long fiber exit 99.1 for bamboo fibers which do not pass the upper length sieve,
a medium long fiber exit 99.2 for bamboo fibers which pass the upper length sieve but do not pass the lower length sieve,
a short fiber exit 99.3 for bamboo fibers which pass the upper length sieve and pass the lower length sieve,

Turning in particular to FIG. 16, the openings area 93 is annular, and in particular circular. The openings area 93 extends around the deposition zone 96. The length sieve device comprises a circumferential wall 105 which forms part of a housing 106 and which extends along a circumference of the at least one length sieve 92. The circumferential wall, when seen in top view, is in particular circular or substantially circular.

Each long fiber exit 99.2, 99.3 comprises at least one opening in the circumferential wall 105. The long fiber exit is located outwardly of the annular openings area and provided in the circumferential wall.

The length sieve drive 97 is configured for moving the length sieve 92 in a gyrating manner, for moving the bamboo fibers from the deposition zone 96 outwardly and away from the deposition zone and across the openings area, as indicated by arrows 109. The circumferential wall 105 will guide bamboo fibers which have crossed the openings area but not directly in the direction of the exit 99 towards the exit 99.

The length sieve drive 97 is configured to move the length sieve 92 only in a horizontal direction and to maintain the length sieve stationary or substantially stationary in a vertical direction, in order to maintain the bamboo fibers in a horizontal orientation and in contact with the length sieve and to prevent the bamboo fibers from becoming airborne. The length sieve drive comprises an unbalanced motor and a support assembly 110 comprising pivotable rods. The support assembly provides freedom of movement of the length sieve in an X-direction and Y-direction, and in particular no freedom of movement or substantially no freedom of movement in a Z-direction. The rods 110 are pivotably mounted to the substructure 111.

Each length sieve device comprises the housing 106 and an air extraction device 67. The air extraction device may comprise a filter and a receptacle for collecting bamboo fibers extracted with the extracting device.

The system 10 comprises a control unit 100. The control unit is configured for controlling a frequency and/or an amplitude of the motion of the length sieve device.

Turning to FIGS. 17A-17F, various possible embodiments of the length sieve openings are shown. In each embodiment, the length sieve openings are arranged in a staggered arrangement. When seen in top view, any straight line 108.1-108.4 which extends across the openings area 93, extends over at least one length sieve opening 94 and in particular extends over multiple length sieve openings 94. In this way fibers which travel across the openings area 93 and have a sufficiently small length will drop through at least one length sieve opening 94.

The bands 102 are circular. In FIG. 17C there are two concentric bands 102.

The length sieve openings 94 have a diameter in a range of 1 mm-40 mm. Different length sieves have length sieve openings 94 of a different diameter. In the shown embodiment, the following length sieves may have the following opening sizes:

| Length sieve device (40) | Length sieve (92) | Opening size |
|---|---|---|
| 40.1 | 92.1 | 2-4 mm |
| 40.1 | 92.2 | 1-2 mm |
| 40.2 | 92.1 | 3-6 mm |
| 40.2 | 92.2 | 1-3 mm |

For length sieve device 40.1, the bamboo fibers that do not pass the upper length sieve 92.1 may have a length of 4-15 mm. For length sieve device 40.2, the bamboo fibers that do not pass the upper length sieve 92.1 may have a length of 6-15 mm. The lower length sieve 92.2 will generally have openings 93 that are smaller than the upper length sieve 92.1 of a same length sieve device 40.

The length sieve openings may be circular or polygonal.

Turning to FIGS. 18A-18F, further embodiments of the length sieve device 40 having two length sieves 92 arranged above one another in a common housing. The length sieve device comprises three exits 99.1-99.3 and in other aspects are similar to the embodiments of FIGS. 17A-17F.

Turning to FIGS. 19A-19F in another embodiment, the length sieve device 40 comprises a left wall 120 and a right wall 121, wherein the openings area 93 extends as a band 102 from the left wall 120 to the right wall 121, wherein the deposition zone 96 is located on an upstream side of the openings area 93, and the long fiber exit 99.1 is located on the opposite, downstream side of the openings area.

In this embodiment, the length sieve drive 97 is configured for moving the length sieve in an oscillatory manner, for moving the bamboo fibers from the deposition zone 220 in a downstream direction across the openings area.

The system 10 is free of any liquid supplying devices for supplying liquid to the bamboo fibers, the system being configured to mill and sieve the bamboo fibers in a dry state and in particular not to process the bamboo as a bamboo pulp. Also, the bamboo fibers are not treated with steam such as with superheated steam.

### Operation

In operation the method of manufacturing bamboo fibers comprises:
supplying bamboo parts to the system 10 according to the present invention,
milling the bamboo parts into bamboo fibers with the at least one milling device 12,
sieving the formed bamboo fibers with the at least one diameter sieve device 18, thereby separating the bamboo fibers in the first width fraction of relatively narrow bamboo fibers and the second width fraction of relatively wide bamboo fibers.

The method may comprise supplying one of the fractions of bamboo fibers which are sieved in the at least one diameter sieve device 18 to the at least one length sieve device 40, and separating the received bamboo fibers in at least one first length fraction 41.1 and at least one second length fraction 41.2 with the at least one length sieve device.

The diameter sieve 18 is abruptly moved over a vertical distance in an oscillatory manner, wherein bamboo fibers which lie on the upper side of the diameter sieve become airborne, and wherein at least some of the airborne bamboo fibers rotate, wherein:
a) rotated bamboo fibers which are narrower than the diameter sieve openings pass through the diameter sieve openings when they fall down on the diameter sieve and are discharged from the diameter sieve device via the narrow diameter exit, and
b) rotated bamboo fibers which are wider than the diameter sieve openings do not pass through the diameter sieve openings and are discharged from the diameter sieve device via the wide diameter exit.

The method comprises feeding the relatively wide bamboo fibers which are discharged from the wide diameter exit of the first set to the milling device of the second set.

The method comprises merging the fractions of relatively narrow bamboo fibers which are discharged via the respective narrow diameter exits 31 of the different diameter sieve devices into a merged fraction of bamboo fibers. The merged fraction of relatively narrow bamboo fibers is fed to the further diameter sieve device 34. The further diameter sieve device separates the merged fraction of relatively narrow bamboo fibers into at least a first width fraction of relatively narrow bamboo fibers and a second width fraction of relatively wide bamboo fibers. The merged fraction may also be directly fed to at least one length feed device, i.e. the system may be carried out without the further diameter sieve device.

The method comprises feeding the first or second width fraction which is discharged from the further diameter sieve device to the at least one length sieve device and separating the bamboo fibers in at least a first length fraction group of relatively long bamboo fibers and a second length fraction of relatively short bamboo fibers with the length sieve device.

The bamboo fibers are oriented horizontally in the length sieve device and are maintained in said horizontal orientation and are maintained in contact with the length sieve device during the sieving in the length sieve device.

The bamboo parts which are used as raw material are bamboo chips and have a longest dimension in a range of 5-50 mm, more in particular 15-45 mm.

The bamboo fibers are separated in multiple fractions, each fraction having a range of diameters and/or a range in lengths.

In the length subsystem 8, the bamboo fibers are separated in:
a first fraction 43 having a diameter in a range of 0-100 μm but not a specified length. This fraction is essentially powder.
a second fraction 41.1 having a diameter in a range of 100-200 μm, and a length in a range of 1-2 mm,
a third fraction 41.2 having a diameter in a range of 100-200 μm, and a length in a range of 2-4 mm,
a fourth fraction 41.3 having a diameter in a range of 100-200 μm, and a length in a range of 4-15 mm,
a fifth fraction 42.1 having a diameter in a range of 200-400 μm, and a length in a range of 1-3 mm,
a fifth fraction 42.2 having a diameter in a range of 200-400 μm, and a length in a range of 3-6 mm,
a fifth fraction 42.3 having a diameter in a range of 200-400 μm, and a length in a range of 5-15 mm.

The bamboo parts which are used are parts of the culm, because the culm provides the strongest fibers. The bamboo parts are typically not bamboo leaves.

### Fiber Mat Production

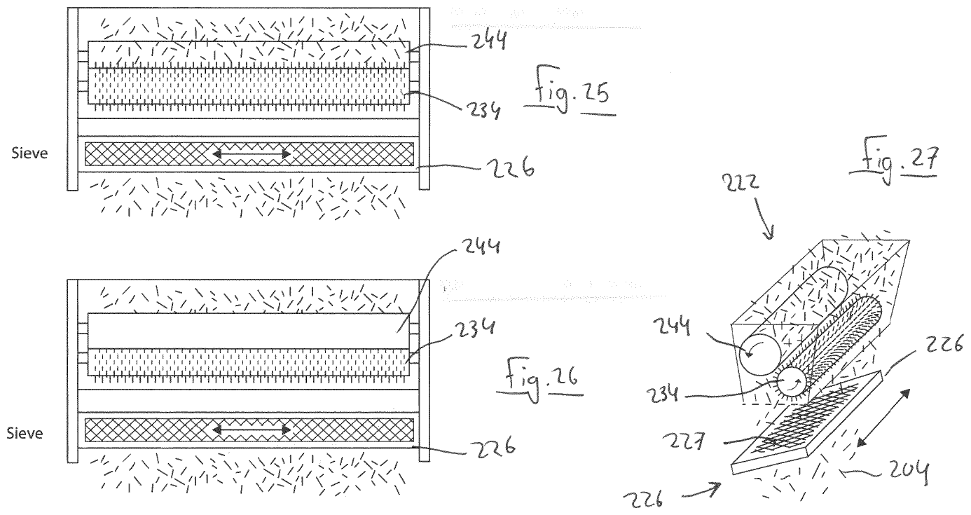

Turning to FIGS. 21-27, in another aspect, the present invention relates to a device 200 for manufacturing a sheet material 202 comprising bamboo fibers 204, the device comprising:
a film material conveying system 206 comprising:
   a spool holder 208 for holding a spool 210 comprising a film material 212, and
   a film material conveyor 214 comprising one or more guides 216 for transporting the film material along a deposition area 220,
a bamboo fiber deposit station 249 which comprises:
   at least one hopper 222 (222A, 222B) configured for holding the bamboo fibers 204, the hopper comprising a hopper exit 224 at a lower side thereof,
   a movable distributor member 226, in particular a distributor sieve, comprising multiple distributor openings 227, the movable distributor member configured for receiving bamboo fibers from the hopper,
   a distributor drive 228 configured for vibrating the distributor member 226A in order to let the bamboo fibers pass the distributor openings and in order to scatter the bamboo fibers evenly as a layer over the film material in the deposition area 220, and
a heating device 230 positioned along the film material conveyor downstream from the deposition area, wherein the heating device is configured for heating the film material, thereby connecting the bamboo fibers to the film material and forming the sheet material.

The movable distributor member 226 is positioned directly below the hopper exit 224 and configured for receiving bamboo fibers which drop from the hopper exit. The distributor drive 228 is configured for moving the distributor member in an oscillating movement, in an X-direction and Y-direction. The openings 227 may be formed by a wire mesh. It was found that the bamboo fibers have a tendency to come together during the fall, because they have little weight and because they may be electrically charged. The movable distributor member 226 and the distributor drive 228 ensure that the layer of bamboo fibers which is formed has a uniform thickness and that the bamboo fibers have varying directions in the layer, and have in particular uniformly distributed directions. This results in a high quality end product.

A first roller 234 (denoted in the figs. as 234A, 235B) is positioned in the hopper. The first roller comprises projections 236. A first roller drive 238 is provided which is configured for rotating the first roller 234 about a first horizontal rotation axis 240.

The projections 236 are elongate and extend over a radial distance. The projections 236 are in particular spikes.

The device 200 comprises a second roller 244 positioned in the hopper 222. A second roller drive may be provided for rotating the second roller about a second horizontal rotation axis. A common drive 238 for the rollers may also be used and is shown in the figures. The second roller may also have projections 236, in particular spikes 236. The projections assist in creating a uniform stream of bamboo fibers from the hopper. The second roller may have a greater diameter than the first roller.

The first and second roller define a roller gap 250 between them. The first and second roller are rotated in a same direction 252, here counterclockwise. A part of the first roller 234 which is located at the gap 252 moves in an opposite direction as a part of the second roller 244 which is located at the opposite side of the gap. The second roller 244 is positioned diagonally above the first roller 234. The part of the first, lower roller 234 which is located at the gap 252 moves the fibers through the gap toward the movable distributor member 226.

The device further comprises a pressing device 260 for pressing the bamboo fibers and the heated film material against one another. The pressing device 260 comprises a roller 262 and a conveyor belt 262 which presses against the sheet material over a considerable length top maintain pressure and drive out possible air bubbles.

A main conveyor 264 is further provided on which the sheet material 212 and the bamboo fibers 204 are positioned. The main conveyor 264 comprises a conveyor belt 265 and conveys the sheet material 212 and the carbon fibers through the pressing device 260 and heating device 230. Downstream from the heating device 230, a cooling device 231 may be provided for cooling the sheet material so that the fibers stay attached in particular when rolling the sheet material into a roll. The cooling device may blow cool air onto the formed sheet material 202. A rotary brush device 232 may be provided downstream from the cooling device 231 to remove excess fibers from the sheet material.

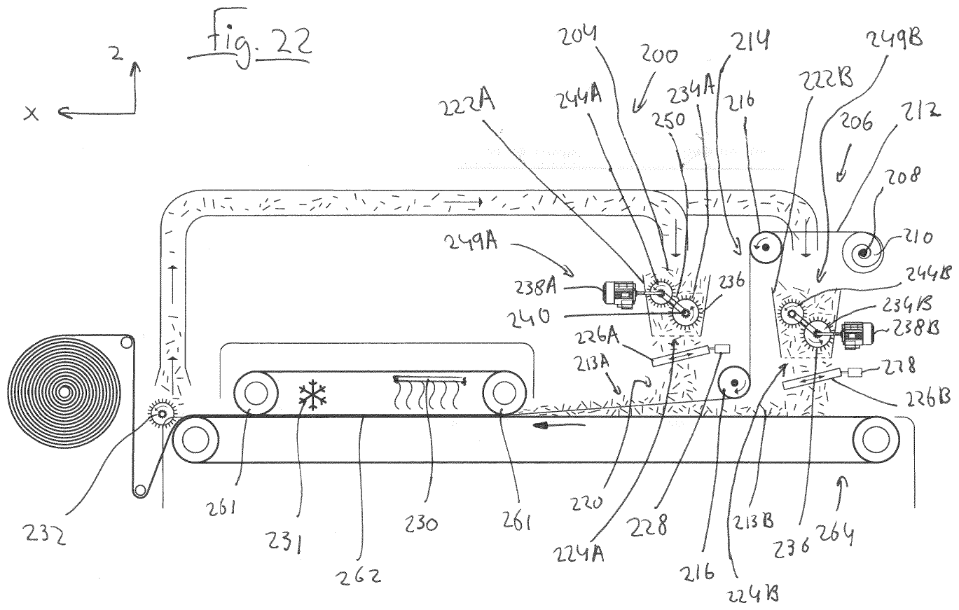

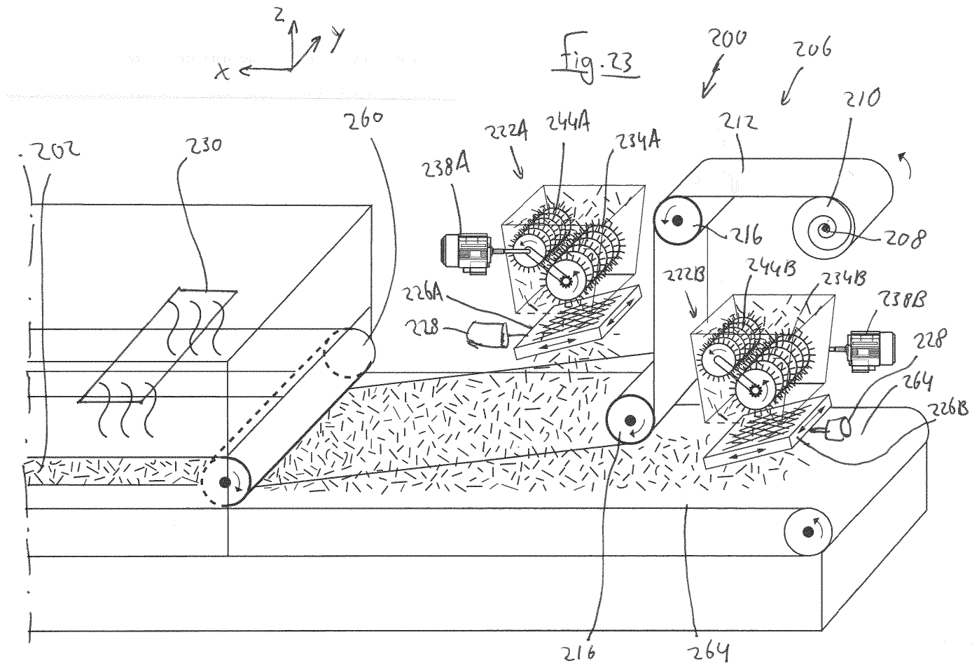

In the embodiment of FIG. 22, a second hopper 222B is provided which deposits bamboo fibers 204 directly on the main conveyor 264. The film material 212 is placed over these bamboo fibers and further bamboo fibers are deposited on the film material from the first hopper 222A. The bamboo fibers in the second hopper 222B may of a same fraction or a different fraction as the bamboo fibers in the first hopper 222B.

The film material is moved continuously along the deposition area, although a start/stop movement would in principle also be possible.

The film material 212 may be a thermoplastic material, in particular PLA, PP, PA11, P12, or Rilsan or solanyl. Several other thermoplasts may be used.

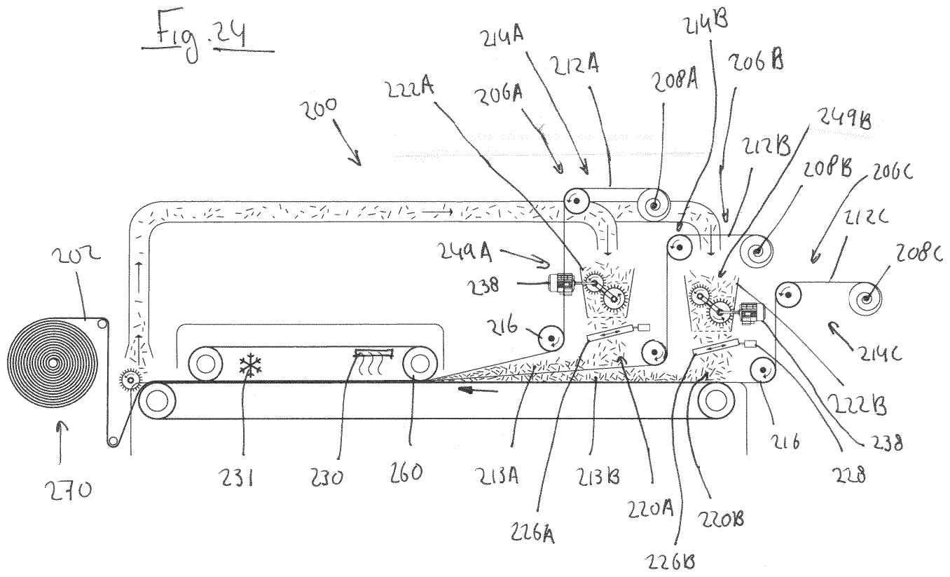

Turning to FIG. 24, in another embodiment the device 200 comprises a second and/or third film material conveying system 206B, 206C. Each film material conveying system 206 comprises a respective spool holder 208A, 208B, 208C for holding a spool 210A, 210B, 210C comprising a film material 212A, 212B, 212C. The device 200 further comprises a second and/or third film material conveyor 214B, 214C comprising a number of guides 216 for transporting the second film material along a second deposition area 220. The film materials 212A, 212B, 212C may be the same but may also be different, which results in sheet material 202 having layers of different thermoplastic materials.

The device 200 comprises at least one second hopper 222B configured for holding bamboo fibers 204. The hopper comprises a second hopper exit 224B at a lower side thereof.

A second movable distributor member 226B is provided which comprises multiple distributor openings 227, the second movable distributor member configured for receiving bamboo fibers from the second hopper,

The second bamboo fiber deposit station 249B comprises a second distributor drive 228B configured for vibrating the second distributor member 226B in order to let the bamboo fibers 204 pass the second distributor openings and in order to scatter the bamboo fibers evenly or substantially evenly as a second layer over the second film material in the second deposition area 220B.

In this embodiment, the pressing device 260 is configured for pressing the first and second (and third) film material 212A, 212B, 212C and the first and second layer of bamboo fibers against one another.

The heating device 230 is configured for heating the first and second film material, thereby connecting the bamboo fibers to the first and second film material and forming the sheet material.

The second film material conveyor may be configured to place the second film material 212A, 212B on top of the bamboo fibers 204 which have been scattered on the first film material 212B, 212C.

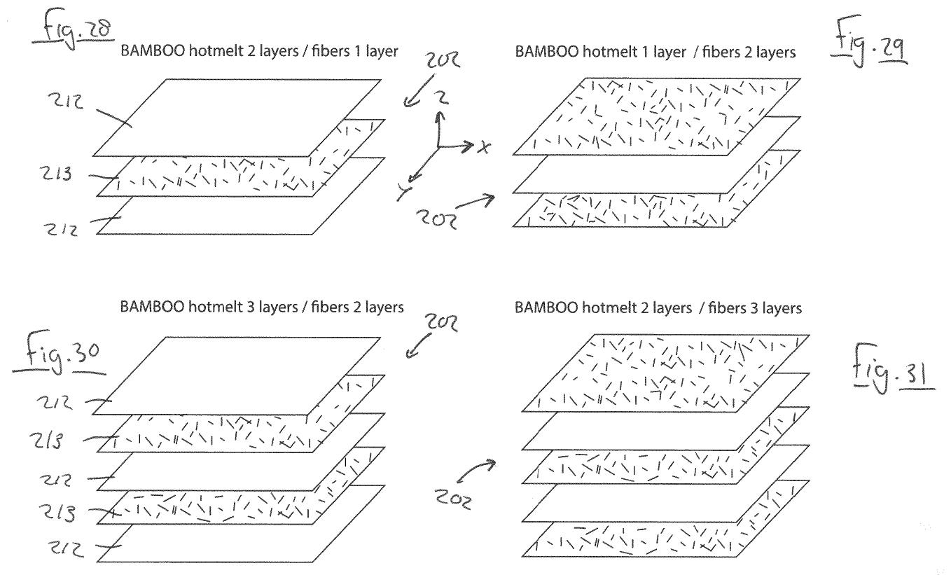

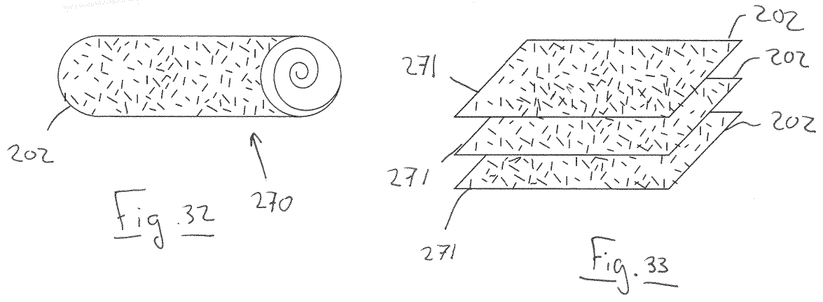

Turning to FIGS. 28-31, various configurations of the sheet material are possible. FIG. 28 shows a sheet material with two layers of film material 212 and one layer 213 of bamboo fibers. FIG. 29 shows a sheet material 202 with two layers of bamboo fiber 213 and one layer of film material 212. FIG. 30 shows a sheet material 202 with two layers of bamboo fiber 213 and three layers of film material 212. FIG. 31 shows a sheet material 202 with three layers of bamboo fiber 213 and two layers of film material 212. The skilled person will understand that other configurations with more layers are possible. With more layers, a thicker sheet material 202 can be manufactured.

The film material may be a thermoplastic material. The bamboo fibers are connected to the film material by the heating and pressing process.

In the sheet material, the bamboo fibers may have a length in a range of 0.5-100 mm, more in particular in a range of 1-40 mm. The sheet material may be manufactured from a specific fraction of bamboo fibers obtained with the system 10, wherein said fraction is sorted by both diameter and length. These fractions may be:

| | | |
|---|---|---|
| Fraction | Diameter | Length |

| | | | | |
|---|---|---|---|---|
| 1 | 0-200 | μm | 1-2 | mm |
| 2 | 0-200 | μm | 2-4 | mm |
| 3 | 0-200 | μm | 4-15 | mm |
| 4 | 200-400 | μm | 1-3 | mm |
| 5 | 200-400 | μm | 3-6 | mm |
| 6 | 200-400 | μm | 5-15 | mm |
| 7 | 400-1000 | μm | 7-30 | mm |
| 8 | >1000 | mm | 7-40 | mm |

Other ranges are also possible. Also, more or less fractions are possible.

In the sheet material, the bamboo fibers are oriented parallel to the surface of the sheet material. The bamboo fibers are oriented parallel to an XY plane, and have random orientations in said XY plane.

The sheet material has a thickness D1 of between 0.2 and 20 mm, in particular between 1 and 10 mm.

Turning to FIG. 34, another embodiment of a bamboo fiber deposit station 249 is shown. The deposit station comprises a first hopper 222.1 and a second hopper 222.2 placed in series. The first hopper 222.1 has a first roller 234 and a second roller 244. The second hopper 222.2 has a first roller 234, a second roller 244 and a third roller 245. 226. The movable distributor member 226 is positioned below the second hopper 222.2.

Upstream from the first and second hopper, a dispersing assembly 300 is provided.

The dispersing assembly 300 comprises a dispersing hopper 301. The dispersing hopper has an entry 302 where the bulk flow of bamboo fibers enters and an exit 304 where the bamboo fibers exit the dispersing hopper. At the exit 304, a first set 305 of a first conveyor belt 306 and a second conveyor belt 308 are provided which convey the bamboo fibers from the dispersing hopper and create a steady flow of bamboo fibers having a horizontal component of movement. The transport direction may be horizontal or inclined. The first conveyor belt is positioned above the second conveyor belt to create a passage 310 between them. At the downstream end of the first set 305 of conveyor belts 306, 308, a first rotatable distributor brush 312 is provided which spreads out the flow of bamboo fibers and creates a thinner flow of bamboo fibers. Downstream from the first rotatable distributor brush 312 a second set 315 of conveyor belts is positioned, comprising a third and fourth conveyor belt 316, 318.

Downstream from the second set 315 a second rotatable distributor brush 322 is provided which further spreads out the flow of bamboo fibers and guides the bamboo fibers into the first hopper 222.1.

The conveyor belts 306, 308, 316, 318 and the rotatable distributor brushes 322 are driven by respective drives 320.

With this embodiment of the fiber deposit station 249 including the dispersing assembly 300, the flow of bamboo fibers into the hoppers 222.1 and 222.1 is controlled to become an evenly distributed flow with a controllable discharge rate. This results in sheet material 202 having an even distribution of bamboo fibers.

### Operation

Turning to FIG. 21, in a method of manufacturing a sheet material 202 comprising bamboo fibers, the method comprises:
loading the hopper 222 of the device according to the invention with bamboo fibers 204,
conveying the film material along the deposition area 220,
depositing bamboo fibers 204 as a layer onto the film material in a scattered manner,
heating the film material in the heating device 230 and connecting the bamboo fibers to the film material.

The method comprises pressing the film material 212 and the layer of bamboo fibers against one another, which essentially is a laminating process.

The method comprises laminating multiple layers of film material 212 and layers 213 of bamboo fibers into a single sheet material 202.

The bamboo fibers used in the device 200 may have a diameter in a defined range and have a length in a defined range. These ranges may according to the table above, but different ranges are possible.

The bamboo fibers used in the device 200 are in particular obtained with the system 10 of the present invention.

In the method a liquid is not added to the bamboo fibers. Steam is also not used. This retains the strength of the bamboo fibers.

Excess bamboo fibers may be brushed from the film material after heating the film material and in particular after the formed sheet material has cooled off.

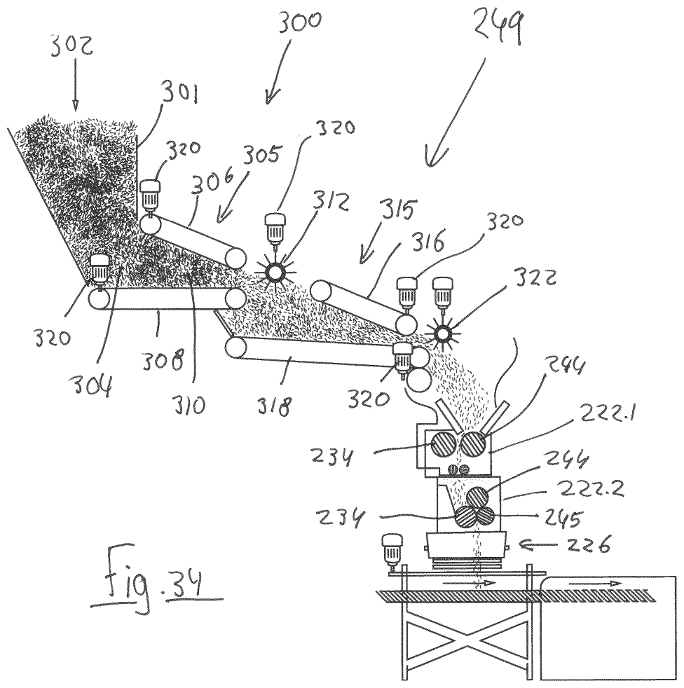

Turning to FIGS. 32 and 33, the sheet material can be provided as a roll 270 or as separate sheets 271.

### CLAUSES

The invention relates to the following numbered clauses:
1. System (10) for manufacturing bamboo fibers (204) from bamboo parts (205), the system comprising:
   at least one milling device (12) configured for milling the bamboo parts (205) into bamboo fibers (204), and
   at least one diameter sieve device (18) configured for separating the bamboo fibers in a first width fraction of relatively narrow bamboo fibers and a second width fraction of relatively wide bamboo fibers, wherein the bamboo fibers of the second width fraction have a greater diameter than the bamboo fibers of the first width fraction.
2. System according to clause 1, further comprising at least one length sieve device (40) positioned downstream from the at least one diameter sieve device and configured for receiving bamboo fibers which have been sieved by the at least one diameter sieve device, wherein the at least one length sieve device is configured for separating the received bamboo fibers in at least a first length fraction of relatively short bamboo fibers and a second length fraction of relatively long bamboo fibers, wherein the bamboo fibers of the second length fraction have a greater length than the bamboo fibers of the first length fraction.
3. System according to any of the preceding clauses, wherein the at least one milling device comprises:
   an upper milling disc (50), in particular an upper millstone, the upper milling disc having at least one entry opening (51),
   a lower milling disc (52), in particular a lower millstone, and
   a milling drive (55), the upper milling disc being positioned above the lower milling disc, wherein the milling drive is configured to rotate at least one of the milling discs about a vertical axis (56).
4. System according to the preceding clause, wherein the milling device comprises a milling control unit (100), a torque sensor which measures a parameter representative of a load on the milling device, in particular a torque between the milling discs, and a controllable supply device (60) configured to control the supply of bamboo fibers through the diameter sieve entry on the basis of a measured torque.
5. System according to any of the preceding clauses, wherein the at least one diameter sieve device (18) comprises:
   a diameter sieve (70) comprising multiple diameter sieve openings (71) having a size which determines a threshold diameter,
   a diameter sieve entry (72) via which the bamboo fibers enter the diameter sieve device and subsequently engage an upper side of the diameter sieve,
   a diameter sieve drive (74) configured for vibrating the diameter sieve (70) over a vertical distance in order to let at least a portion of the bamboo fibers become airborne, in order to reorient the bamboo fibers to a vertical or substantially vertical orientation, wherein in operation the bamboo fibers having a diameter smaller than the threshold diameter pass the diameter sieve through the diameter sieve openings, and wherein the bamboo fibers having a diameter larger than the threshold diameter do not pass the sieve but remain on the upper side of the sieve,
   at least one narrow diameter exit (31) via which the relatively narrow bamboo fibers which have passed the diameter sieve are discharged from the diameter sieve device,
   at least one wide diameter exit (32) via which the relatively wide bamboo fibers which have not passed the diameter sieve are discharged from the diameter sieve device.
6. System according to the preceding clause, wherein a width of the diameter sieve openings of the diameter sieve device (18) is in a range of 300-2000 μm, in particular 300-1500 μm.
7. System according to clauses 5 or 6, wherein the diameter sieve drive is configured for each time abruptly moving the diameter sieve in a vertical direction, in particular in an upward direction, wherein the bamboo fibers which lie on the upper side of the diameter sieve become airborne as a result of the abrupt movement.
8. System according to the preceding clause, wherein the diameter sieve drive (74) comprises one or more hitting members (76) which are constructed to repeatedly hit the diameter sieve from below.
9. System according to any of the preceding clauses 5-8, wherein:
   one or more diameter sieve devices comprises a supply end (78) and a discharge end (79) provided on opposite ends of the diameter sieve, wherein when seen in top view the diameter sieve entry is located on the supply end and the narrow and wide diameter exits are located on the discharge end, wherein the diameter sieve drive is configured for moving the bamboo fibers from the supply end in the direction of the discharge end,
   or
   one or more diameter sieves have a round shape when seen in top view, and wherein the narrow diameter exit is provided at the circumference of the diameter sieve, wherein the diameter sieve entry is located centrally, wherein the diameter sieve drive is configured for moving the bamboo fibers outwardly away from the center.
10. System according to clause 9, wherein when seen in top view the diameter sieve device has a rectangular or square shape.
11. System according to any of clauses 5-10, wherein the diameter sieve is formed by a mesh (81), in particular a wire mesh, wherein when seen in top view the diameter sieve openings in particular have a polygonal shape, more in particular a rectangular, square or diamond shape.
12. System according to any of the preceding clauses 5-11, wherein the diameter sieve device comprises:
   a sieve brush (170), and
   a brush drive (171),
   wherein the brush drive is configured to move the brush over the diameter sieve in order to move the bamboo fibers which have not passed the diameter sieve to the at least one wide diameter exit.
13. System according to any of the preceding clauses, comprising a diameter subsystem (6) which comprises at least a first set (25.1) and a second set (25.2) which are placed in series, each set comprising:
   at least one milling device (12), and
   at least one diameter sieve device (18) configured to receive bamboo fibers from the milling device of the same set,
   wherein the system comprises a feed trajectory (26) which extends from the diameter sieve device of the first set to the milling device of the second set, for feeding the fraction of relatively wide bamboo fibers which are discharged from the wide diameter exit of the first set to the milling device of the second set.
14. System according to the preceding clause, comprising between three sets and ten sets, in particular at least four sets, which are placed in series and interconnected by a respective feed trajectory.
15. System according to the preceding clause, wherein the diameter sieve devices of multiple sets have a same size of the diameter sieve openings and a same threshold diameter.
16. System according to the preceding clause, wherein the threshold diameter is between 200 and 600 μm, in particular 400 μm.
17. System according to any of clauses 13-16, comprising a merge trajectory (28), in particular formed by at least one merge conveyor having multiple entry openings (30), wherein the fractions of relatively narrow bamboo fibers which are discharged via the respective narrow diameter exits (31) of the diameter sieve devices are entered into the merge trajectory via an entry opening (30) in order to be merged into a merged fraction of relatively narrow bamboo fibers.
18. System according to the preceding clause, comprising a further diameter sieve device (34) configured for receiving the merged fraction of relatively narrow bamboo fibers and for separating the merged fraction of relatively narrow bamboo fibers into at least a first width fraction of relatively narrow bamboo fibers and a second width fraction of relatively wide bamboo fibers, and in particular into three separate width fractions.
19. System according to any of the preceding clauses, comprising at least one return flow trajectory (351) extending from the most downstream diameter sieve device (18.5) to at least one milling device positioned further upstream, for returning a fraction of relatively wide bamboo fibers which have not passed the at least one diameter sieve of the downstream diameter sieve device to the milling device positioned further upstream for re-processing the fraction.
20. System according to the preceding clauses, wherein the downstream diameter sieve device (18.4) comprises two diameter sieves (70.1, 70.2) positioned above one another, wherein the fraction of bamboo fibers which does not pass the upper diameter sieve (70.1) enters the return flow trajectory (351), wherein the fraction of bamboo fibers which passes the upper diameter sieve but not the lower diameter sieve is fed to a downstream milling device (12.5), and wherein the fraction which passes both diameter sieves (70.1, 70.2) enters the merge trajectory (351).
21. System according to any of clauses 18-20, wherein the at least one length sieve device is configured for receiving the merged fraction of relatively narrow bamboo fibers.
22. System according to any of clauses 19-21, wherein the at least one length sieve device is positioned downstream from the further diameter sieve device (34) and configured for receiving a width fraction, in particular the first or second width fraction, which is discharged from the further diameter sieve device.
23. System according to the preceding clause, comprising a length subsystem (8) comprising at least the first length sieve device and a second length sieve device, the first and second length sieve device being positioned downstream from the further diameter sieve device,
   wherein the first length sieve device receives the first width fraction and further separates the first width fraction into at least a first length fraction of relatively long bamboo fibers and a second length fraction of relatively short bamboo fibers,
   wherein the second length sieve device receives the second width fraction and further separates the second width fraction into at least a third length fraction of relatively long bamboo fibers and a fourth length fraction of relatively short bamboo fibers.
24. System according to any of clauses 2-23, wherein the at least one length sieve device (40) comprises:
   at least one length sieve (92) comprising an openings area (93) which comprises multiple length sieve openings (94), and
   a length sieve entry (95) located at an upstream side of the openings area, wherein bamboo fibers which enter the length sieve via the length sieve entry are deposited on a deposition zone (96) on the at least one length sieve,
   a length sieve drive (97) configured for vibrating the length sieve over a horizontal distance in order to move the bamboo fibers from the deposition zone over the length sieve and across the openings area, wherein relatively short bamboo fibers drop through the length sieve openings and wherein relatively long bamboo fibers travel across the length sieve openings without dropping through the length sieve openings,
   a long fiber exit (99.3) via which the first length fraction of relatively long bamboo fibers which have travelled across the openings area is discharged from the length sieve device, and
   a short fiber exit (99.1, 99.2) via which the second length fraction of relatively short bamboo fibers which have dropped through the length sieve openings are discharged from the length sieve device.
25. System according to clause 24, wherein the openings area has the shape of at least one band (102) having a band length (103) and a band width (104), wherein the length sieve drive is configured to move the bamboo fibers across the band-shaped openings area.
26. System according to any of clauses 24-25, wherein the length sieve openings are arranged in a staggered arrangement, wherein when seen in top view any straight line extending across the openings area extends over at least one length sieve opening and in particular extends over multiple length sieve openings.
27. System according to any of clauses 24-26, wherein when seen in top view:
   the openings area is annular, and in particular circular, wherein the openings area extends around the deposition zone (96), wherein the length sieve device comprises a circumferential wall (105) which extends along a circumference of the at least one length sieve, wherein the circumferential wall, when seen in top view, is in particular circular or substantially circular, wherein the long fiber exit (99.2, 99.3) comprises at least one opening in the circumferential wall and wherein the long fiber exit is located outwardly of the annular openings area and provided in the circumferential wall,
   or
   the length sieve device comprises a left wall (120) and a right wall (121), wherein the openings area extends as a band from the left wall to the right wall, wherein the deposition zone is located on an upstream side of the openings area, and the long fiber exit is located on the opposite, downstream side of the openings area.
28. System according to the preceding clause, wherein the length sieve device has the configuration of clause 27 and wherein the length sieve drive is configured for moving the length sieve in a gyrating manner, for moving the bamboo fibers from the deposition zone (96) outwardly and away from the deposition zone and across the openings area,
   or
   wherein the length sieve device has the configuration of clause 27 and wherein the length sieve drive is configured for moving the length sieve in an oscillatory manner, for moving the bamboo fibers from the deposition zone in a downstream direction across the openings area.
29. System according to any of clauses 24-28, wherein the length sieve drive is configured to move the length sieve only in a horizontal direction and to maintain the length sieve stationary or substantially stationary in a vertical direction, in order to maintain the bamboo fibers in a horizontal orientation and in contact with the length sieve and to prevent the bamboo fibers from becoming airborne.
30. System according to any of clauses 24-29, wherein the length sieve openings have a diameter in a range of 0.5 mm-30 mm.
31. System according to any of clauses 24-30, wherein the length sieve is a plate and wherein the multiple length sieve openings are formed in the plate.
32. System according to any of clauses 24-31, wherein the length sieve openings are circular or polygonal.
33. System according to any of clauses 2-32, wherein at least one length sieve device comprises at least an upper length sieve (92.1) having an upper long fiber exit and a lower length sieve having a lower long fiber exit which are mounted in a common housing (105), wherein the upper length sieve is positioned above the lower length sieve, wherein the lower length sieve (92.2) comprises length sieve openings which are smaller than the length sieve openings of the upper length sieve, the at least one length sieve device comprising at least three exits:
   an extra long fiber exit for bamboo fibers which do not pass the upper length sieve,
   a medium long fiber exit for bamboo fibers which pass the upper length sieve but do not pass the lower length sieve,
   a short fiber exit for bamboo fibers which pass the upper length sieve and pass the lower length sieve.
34. System according to any of clauses 2-33, wherein each length sieve device comprises a housing and an air extraction device, the air extraction device comprising a filter and a receptacle for collecting bamboo fibers extracted with the air extracting device.
35. System according to any of clauses 2-34, wherein each length sieve drive comprises an unbalanced motor (97) and a support assembly (110) which provides freedom of movement of the length sieve in an X-direction and Y-direction, and in particular no freedom of movement or substantially no freedom of movement in a Z-direction.
36. System according to any of clauses 2-35, comprising a control unit (100), wherein the control unit is configured for controlling a frequency and/or an amplitude of the motion of the length sieve device.
37. System according to any of the preceding clauses, wherein the system is free of any liquid supplying devices for supplying liquid to the bamboo fibers, the system being configured to mill and sieve the bamboo fibers in a dry state and in particular not to process or pre-process the bamboo parts/fibers as a bamboo pulp and not to process the bamboo parts/fibers with steam.
38. System according to clause 1, comprising at least a first set and a second set placed in series, each set comprising:
   at least one milling device (12), wherein each milling device comprises:
      an upper milling disc, in particular an upper milling stone, the upper milling disc having at least one entry opening,
      a lower milling disc, in particular a lower milling stone, and
      a milling drive,
   the upper milling disc being positioned above the lower milling disc, wherein the milling drive is configured to rotate at least one of the milling discs about a vertical axis (56),
   a diameter subsystem (6) comprising at least one diameter sieve device (18) configured to receive bamboo fibers from the milling device of the same set,
   wherein each diameter sieve device comprises:
      a diameter sieve comprising multiple diameter sieve openings having a size which determines a threshold diameter,
      a diameter sieve entry via which the bamboo fibers enter the diameter sieve device and subsequently engage an upper side of the diameter sieve,
      a diameter sieve drive configured for vibrating the diameter sieve over a vertical distance in order to let at least a portion of the bamboo fibers become airborne, in order to reorient the bamboo fibers to a vertical or substantially vertical orientation, wherein in operation the bamboo fibers having a diameter smaller than the width of the diameter sieve openings pass the diameter sieve through the diameter sieve openings, and wherein the bamboo fibers having a diameter larger than the size of the diameter sieve openings do not pass the sieve but remain on the upper side of the sieve,
      at least one wide diameter exit (32) via which the relatively wide bamboo fibers which have not passed the diameter sieve are discharged from the diameter sieve device,
      at least one narrow diameter exit (31) via which the relatively narrow bamboo fibers which have passed the diameter sieve are discharged from the diameter sieve device,
   wherein the system comprises a feed trajectory (21) between each set, the feed trajectory configured for feeding the relatively wide bamboo fibers which are discharged from the wide diameter exit of a set to the milling device of the next set in series,
   the system comprising at least one return flow trajectory (35) extending from the most downstream diameter sieve device to at least one milling device positioned further upstream, for returning a fraction of relatively wide bamboo fibers which have not passed the diameter sieve of downstream diameter sieve device to the milling device positioned further upstream for re-processing the fraction,
   the system further comprising a merge trajectory (28), in particular formed by at least one merge conveyor having multiple entry openings, wherein the fractions of relatively narrow bamboo fibers which are discharged via the respective narrow diameter exits of the diameter sieve devices are entered into the merge trajectory via an entry opening in order to be merged into a merged fraction of relatively narrow bamboo fibers,
   the system further comprising a further diameter sieve device (34) configured for receiving the merged fraction of relatively narrow bamboo fibers and for separating the merged fraction of relatively narrow bamboo fibers into at least a first width fraction of relatively narrow bamboo fibers and a second width fraction of relatively wide bamboo fibers,
   the system further comprising a length subsystem (8) comprising at least a first length sieve device and a second length sieve device, the first and second length sieve device being positioned downstream from the further diameter sieve device,
   wherein the first length sieve device receives the first width fraction and further separates the first width fraction into at least a first length fraction of relatively long bamboo fibers and a second length fraction of relatively short bamboo fibers,
   wherein the second length sieve device receives the second width fraction and further separates the second width fraction into at least a third length fraction of relatively long bamboo fibers and a fourth length fraction of relatively short bamboo fibers.
39. Method of manufacturing bamboo fibers from bamboo parts, the method comprising:
   supplying bamboo parts to the system according to any of the preceding clauses,
   milling the bamboo parts into bamboo fibers with the at least one milling device,
   sieving the formed bamboo fibers with the at least one diameter sieve device, thereby separating the bamboo fibers in the first width fraction of relatively narrow bamboo fibers and the second width fraction of relatively wide bamboo fibers.
40. Method according to the preceding method clause, comprising supplying one of the fractions of bamboo fibers which are sieved in the at least one diameter sieve device of a diameter subsystem (6) to a length subsystem (8) comprising at least one length sieve device according any of clauses 2-38, and separating the received bamboo fibers in the at least one first length fraction and the at least one second length fraction with the at least one length sieve device.
41. Method according to the clause 39 or 40, wherein the diameter sieve is abruptly moved over a vertical distance in an oscillatory manner, wherein bamboo fibers which lie on the upper side of the diameter sieve become airborne, and wherein at least some of the airborne bamboo fibers rotate, wherein:
   rotated bamboo fibers which are narrower than the diameter sieve openings pass through the diameter sieve openings when they fall down on the diameter sieve and are discharged from the diameter sieve device via the narrow diameter exit, and
   rotated bamboo fibers which are wider than the diameter sieve openings do not pass through the diameter sieve openings and are discharged from the diameter sieve device via the wide diameter exit.
42. Method according to any of clauses 38-41, wherein a system according to any of clauses 14-38 is used, the method comprising:
   discharging the relatively narrow bamboo fibers which have passed the diameter sieve via the narrow diameter exit of each set,
   feeding the relatively wide bamboo fibers which are discharged from the wide diameter exit of each set to the milling device of the next set,
   wherein a total flow of bamboo fibers which is passed on from one set to the next set decreases with each set.
43. Method according to any of the preceding method clauses, wherein a system according to any of clauses 14-38 is used, the method comprising merging the fractions of relatively narrow bamboo fibers which are discharged via the respective narrow diameter exits of the different diameter sieve devices into a merged fraction of bamboo fibers which follows the merge trajectory, wherein a total flow of bamboo fibers which follows the merge trajectory increases with each set.
44. Method according to the preceding method clause, wherein a system according to any of clauses 18-38 is used, wherein the merged fraction of relatively narrow bamboo fibers is fed to the further diameter sieve device, wherein the further diameter sieve device separates the merged fraction of relatively narrow bamboo fibers into at least a first width fraction of relatively narrow bamboo fibers and a second width fraction of relatively wide bamboo fibers.
45. Method according to the preceding method clause, the method comprising feeding the first or second width fraction which is discharged from the further diameter sieve device to the at least one length sieve device and separating the bamboo fibers in at least a first length fraction of relatively long bamboo fibers and a second length fraction of relatively short bamboo fibers with the length sieve device.
46. Method according to the preceding clause, wherein the bamboo fibers are oriented horizontally in the length sieve device and are maintained in said horizontal orientation and are maintained in contact with the length sieve device during the sieving in the length sieve device.
47. Method according to any of the preceding method clauses, wherein the bamboo parts which are used as raw material are bamboo chips and have a longest dimension in a range of 5-50 mm, more in particular 15-45 mm.
48. Method according to any of the preceding method clauses, wherein the bamboo fibers are separated in multiple fractions, each fraction having a range of diameters and/or a range in lengths, wherein in particular the bamboo fibers are separated in at least three width fractions, a small width fraction having a diameter which is smaller than a first threshold diameter, a medium width fraction having a diameter which is greater than the first threshold diameter and smaller than a second threshold diameter and a large width fraction having a diameter which is greater than the second threshold diameter, wherein the first threshold diameter lies in a range of 100-300 μm, in particular 200 μm, and wherein the second threshold diameter lies in a range of 300-500 μm, in particular 400 μm, and wherein at least two of the width fractions are further separated in at least two length fractions according to one or more threshold lengths, wherein the one or more threshold lengths lie in a range of 1-15 mm.
49. Method according to any of the preceding method clauses, wherein the bamboo fibers are separated in at least:
   a first fraction having a diameter in a range of 0-100 μm but not a specified length,
   a second fraction having a diameter in a range of 100-200 μm, and a length in a range of 1-2 mm,
   a third fraction having a diameter in a range of 100-200 μm, and a length in a range of 2-4 mm,
   a fourth fraction having a diameter in a range of 100-200 μm, and a length in a range of 4-15,
   a fifth fraction having a diameter in a range of 200-400 μm, and a length in a range of 1-3 mm,
   a sixth fraction having a diameter in a range of 200-400 μm, and a length in a range of 3-6 mm,
   a seventh fraction having a diameter in a range of 200-400 μm, and a length in a range of 5-15 mm, and
   an eighth fraction having a diameter in a range of 400-1000 μm, and a length in a range of 7-30 mm.
50. Method according to any of the preceding method clauses, wherein the milling process and the sieving process(es) are dry in that the bamboo parts which are used as raw material are dry and no liquid is added to the bamboo fibers during the processing of the bamboo parts.
51. Method according to any of the preceding method clauses, wherein the bamboo parts are parts of the culm.
52. Method according to any of the preceding method clauses, wherein the bamboo parts are not bamboo leaves.
53. Device (200) for manufacturing a sheet material (202) comprising bamboo fibers (204), the device comprising:
   a film material conveying system (206) comprising:
      a spool holder (208) for holding a spool (210) comprising a film material (212), and
      a film material conveyor (214) comprising one or more guides (216) for transporting the film material along a deposition area (220),
   a bamboo fiber deposit station (249; 249A, 249B) for depositing a first layer of bamboo fibers, the bamboo fiber deposit station comprising:
      at least one hopper (222) configured for holding bamboo fibers (204), the hopper comprising a hopper exit (224) at a lower side thereof,
      a movable distributor member (226), in particular a distributor sieve, comprising multiple distributor openings (227), the movable distributor member configured for receiving bamboo fibers from the hopper,
      a distributor drive (228) configured for vibrating the distributor member in order to let the bamboo fibers pass the distributor openings and in order to scatter the bamboo fibers evenly as a layer over the film material in the deposition area, wherein the layer has a uniform thickness and wherein the bamboo fibers in the layer have evenly distributed orientations, and
   a heating device (230) positioned along the film material conveyor downstream from the deposition area, wherein the heating device is configured for heating the film material, thereby connecting the bamboo fibers to the film material and forming the sheet material, and
   a pressing device for pressing the heated film material and bamboo fibers onto one another.
54. Device according to the preceding clause, wherein the movable distributor member is positioned directly below the hopper exit and configured for receiving bamboo fibers which drop from the hopper exit.
55. Device according to clause 51 or 52, wherein the distributor drive is configured for moving the distributor member in an oscillating movement.
56. Device according to any of clauses 51-53, comprising:
   a first roller (234) positioned in the hopper, wherein the first roller comprises projections,
   a first roller drive (238) configured for rotating the first roller about a first horizontal rotation axis.
57. Device according to the preceding clause, wherein the projections are elongate and extend radially, wherein the projections are in particular spikes.
58. Device according to clause 54 or 55, comprising:
   a second roller (244) positioned in the hopper,
   a second roller drive or common drive (238) configured for rotating the second roller about a second horizontal rotation axis,
   wherein the first and second roller define a roller gap (250) between them, and wherein the first and second roller are rotated in a same direction, wherein a part of the first roller which is located at the gap moves in an opposite direction as a part of the second roller which is located at the opposite side of the gap.
59. Device according to the preceding clause, wherein the second roller is positioned diagonally above the first roller.
60. Device according to any of clauses 51-57, further comprising a cooling device positioned downstream from the heating device and configured for cooling the formed sheet material.
61. Device according to any of clauses 51-58, further comprising at least one second film material conveying system (206B, 206C) comprising:
   a second spool holder (208B, 208C) for holding a second spool (210B, 210C) comprising a second film material (212B, 212C), and
   a second film material conveyor (206B, 206C) comprising a number of second guides for transporting the second film material along a second deposition area (220B),
   wherein the heating device is configured for heating the at least first and second layers of film material, and
   wherein the pressing device is configured for pressing the heated at least first and second layers of film material and the one or more layers of bamboo fibers against one another, thereby, thereby connecting the bamboo fibers to the first and second film material and forming the sheet material.
62. Device according to any of clauses 51-59, further comprising a second bamboo deposit station (249) for depositing a second layer of bamboo fibers, the second bamboo deposit station comprising:
   at least one second hopper (222B) configured for holding bamboo fibers ( ) the hopper comprising a second hopper exit ( ) at a lower side thereof,
   a second movable distributor member (226B) comprising multiple distributor openings, the second movable distributor member configured for receiving bamboo fibers from the second hopper,
   a second distributor drive (228B) configured for vibrating the second distributor member in order to let the bamboo fibers pass the second distributor openings and in order to scatter the bamboo fibers evenly or substantially evenly over the second film material in the second deposition area as a second layer having a uniform thickness,
   wherein the pressing device is configured for pressing the one or more layers of film material and the first and second layer of bamboo fibers against one another, and wherein the heating device is configured for heating the one or more layers of film material, thereby connecting the bamboo fibers to the first and second film material and forming the sheet material.
63. Device according to the preceding clause, wherein the second film material conveyor is configured to place the second film material on top of the bamboo fibers which have been scattered on the first film material.
64. Method of manufacturing a sheet material (202) comprising bamboo fibers, the method comprising:
   loading the hopper of the device according to any of clauses 51-61 with bamboo fibers,
   conveying the film material along the deposition area,
   depositing bamboo fibers as a layer onto the film material in a scattered manner,
   heating the film material in the heating device and connecting the bamboo fibers to the film material, and
   pressing the film material and the layer of bamboo fibers against one another.
65. Method according to clause 62, comprising laminating multiple layers of film material and multiple layers of bamboo fibers into a single sheet material.
66. Method according to any of clauses 62-63, wherein the film material is moved continuously along the deposition area.
67. Method according to any of clauses 62-64, wherein the bamboo fibers have a length in a range of 1-40 mm.
68. Method according to any of clauses 62-65, wherein the bamboo fibers are obtained with the system of any of clauses 1-38 and with the method according to any of clauses 39-50.
69. Method according to any of clauses 62-66, wherein the film material is a thermoplastic material, in particular PLA, PP, PA11, P12, or Rilsan.
70. Method according to any of clauses 62-67, wherein no liquid is added to the bamboo fibers and no steam is applied.
71. Method according to any of clauses 62-68, comprising brushing excess bamboo fibers from the film material after heating the film material.
72. Method according to any of clauses 62-69, wherein the sheet material has a thickness of between 0.2 and 10 mm.
73. Sheet material (202) comprising bamboo fibers and a thermoplastic material which interconnects the bamboo fibers.
74. Sheet material according to the preceding clause. comprising:
   one or more layers (212) of film material,
   one or more layers (213) of bamboo fibers,
   wherein the bamboo fibers are connected to the film material.
75. Sheet material according to the preceding clause, wherein the at least one layer of film material is a thermoplastic.
76. Sheet material according to any of clauses 71-73, wherein the bamboo fibers form one or more fractions, wherein each fraction is defined by a range of lengths and by a range of diameters.
77. Sheet material according to the preceding clause, wherein the bamboo fibers form one of the following fractions:

### Fraction Diameter Length

| | | |
|---|---|---|
| Fraction | Diameter | Length |

| | | | | |
|---|---|---|---|---|
| 1 | 0-200 | μm | 1-2 | mm |
| 2 | 0-200 | μm | 2-4 | mm |
| 3 | 0-200 | μm | 4-15 | mm |
| 4 | 200-400 | μm | 1-3 | mm |
| 5 | 200-400 | μm | 3-6 | mm |
| 6 | 200-400 | μm | 5-15 | mm |
| 7 | 400-1000 | μm | 7-30 | mm |

| | | | |
|---|---|---|---|
| 8 | >1000 mm | 7-40 | mm |

78. Sheet material according to any of clauses 71-74, wherein the bamboo fibers are oriented parallel to the surface of the sheet material, i.e., are oriented parallel to an XY plane, and have random orientations in said XY plane.
79. Sheet material according to any of clauses 71-76, wherein the sheet material has a thickness (D1) of between 0.2 and 20 mm, in particular between 1 and 10 mm.
80. Sheet material according to any of clauses 71-77, manufactured with the method according to any of clauses 62-71 and with the device according to any of clauses 51-61.
81. Sheet material according to any of clauses 71-78, comprising multiple layers, wherein different layers comprise bamboo fibers of a different fraction with regard to length and/or diameter range.
82. Sheet material according to any of clauses 71-79, comprising multiple layers, wherein different layers comprise a different thermoplastic material.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects. The mere fact that certain measures are recited in mutually different dependent claims does not indicate that a combination of these measures cannot be used to advantage. White lines between text paragraphs in the text above indicate that the technical features presented in the paragraph may be considered independent from technical features discussed in a preceding paragraph or in a subsequent paragraph.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

1.-84. (canceled)

85. A system for manufacturing bamboo fibers from bamboo parts, the system comprising a diameter subsystem which comprises at least a first set and a second set which are placed in series, each set comprising:
at least one milling device configured for milling the bamboo parts into bamboo fibers, and
at least one diameter sieve device configured for separating the bamboo fibers in a first width fraction of relatively narrow bamboo fibers and a second width fraction of relatively wide bamboo fibers, wherein the bamboo fibers of the second width fraction have a greater diameter than the bamboo fibers of the first width fraction,
wherein the system comprises a feed trajectory which extends from the diameter sieve device of the first set to the milling device of the second set, for feeding the fraction of relatively wide bamboo fibers which are discharged from the wide diameter exit of the first set to the milling device of the second set.

86. The system according to claim 85, further comprising at least one length sieve device positioned downstream from the at least one diameter sieve device and configured for receiving bamboo fibers which have been sieved by the at least one diameter sieve device, wherein the at least one length sieve device is configured for separating the received bamboo fibers in at least a first length fraction of relatively short bamboo fibers and a second length fraction of relatively long bamboo fibers, wherein the bamboo fibers of the second length fraction have a greater length than the bamboo fibers of the first length fraction.

87. The system according to claim 85, wherein the at least one milling device comprises:
an upper milling disc, the upper milling disc having at least one entry opening,
a lower milling disc, and
a milling drive,
the upper milling disc being positioned above the lower milling disc, wherein the milling drive is configured to rotate at least one of the milling discs about a vertical axis, wherein the milling device comprises a milling control unit, a torque sensor which measures a parameter representative of a load on the milling device, and a controllable supply device configured to control the supply of bamboo fibers through the diameter sieve entry on the basis of a measured torque.

88. The system according to claim 85, wherein the at least one diameter sieve device comprises:
a diameter sieve comprising multiple diameter sieve openings having a size which determines a threshold diameter,
a diameter sieve entry via which the bamboo fibers enter the diameter sieve device and subsequently engage an upper side of the diameter sieve,
a diameter sieve drive configured for vibrating the diameter sieve over a vertical distance in order to let at least a portion of the bamboo fibers become airborne, in order to reorient the bamboo fibers to a vertical or substantially vertical orientation, wherein in operation the bamboo fibers having a diameter smaller than the threshold diameter pass the diameter sieve through the diameter sieve openings, and wherein the bamboo fibers having a diameter larger than the threshold diameter do not pass the sieve but remain on the upper side of the sieve,
at least one narrow diameter exit via which the relatively narrow bamboo fibers which have passed the diameter sieve are discharged from the diameter sieve device,
at least one wide diameter exit via which the relatively wide bamboo fibers which have not passed the diameter sieve are discharged from the diameter sieve device,
wherein a width of the diameter sieve openings of the diameter sieve device is in a range of 300-2000 μm,
wherein the diameter sieve drive is configured for each time abruptly moving the diameter sieve in a vertical direction, wherein the bamboo fibers which lie on the upper side of the diameter sieve become airborne as a result of the abrupt movement,
wherein the diameter sieve drive comprises one or more hitting members which are constructed to repeatedly hit the diameter sieve from below.

89. The system according to claim 88, wherein:
one or more diameter sieve devices comprises a supply end and a discharge end provided on opposite ends of the diameter sieve, wherein when seen in top view the diameter sieve entry is located on the supply end and the narrow and wide diameter exits are located on the discharge end, wherein the diameter sieve drive is configured for moving the bamboo fibers from the supply end in the direction of the discharge end, or
one or more diameter sieves have a round shape when seen in top view, and wherein the narrow diameter exit is provided at the circumference of the diameter sieve, wherein the diameter sieve entry is located centrally, wherein the diameter sieve drive is configured for moving the bamboo fibers outwardly away from the center.

90. The system according to claim 88, wherein the diameter sieve is formed by a mesh, wherein when seen in top view the diameter sieve openings have a polygonal shape.

91. The system according to claim 88, wherein the diameter sieve device comprises:
a sieve brush, and
a brush drive,
wherein the brush drive is configured to move the brush over the diameter sieve in order to move the bamboo fibers which have not passed the diameter sieve to the at least one wide diameter exit.

92. The system according to claim 85, comprising a merge trajectory, wherein the fractions of relatively narrow bamboo fibers which are discharged via the respective narrow diameter exits of the diameter sieve devices are entered into the merge trajectory via an entry opening in order to be merged into a merged fraction of relatively narrow bamboo fibers, wherein the system comprises a further diameter sieve device configured for receiving the merged fraction of relatively narrow bamboo fibers and for separating the merged fraction of relatively narrow bamboo fibers into at least a first width fraction of relatively narrow bamboo fibers and a second width fraction of relatively wide bamboo fibers.

93. The system according to claim 85, comprising at least one return flow trajectory extending from the most downstream diameter sieve device to at least one milling device positioned further upstream, for returning a fraction of relatively wide bamboo fibers which have not passed the at least one diameter sieve of the downstream diameter sieve device to the milling device positioned further upstream for re-processing the fraction, wherein the downstream diameter sieve device comprises two diameter sieves positioned above one another, wherein the fraction of bamboo fibers which does not pass the upper diameter sieve enters the return flow trajectory, wherein the fraction of bamboo fibers which passes the upper diameter sieve but not the lower diameter sieve is fed to a downstream milling device, and wherein the fraction which passes both diameter sieves enters the merge trajectory.

94. The system according to claim 86, wherein the at least one length sieve device is positioned downstream from the further diameter sieve device and configured for receiving a width fraction which is discharged from the further diameter sieve device,
wherein the system comprises a length subsystem comprising at least the first length sieve device and a second length sieve device, the first and second length sieve device being positioned downstream from the further diameter sieve device,
wherein the first length sieve device receives the first width fraction and further separates the first width fraction into at least a first length fraction of relatively long bamboo fibers and a second length fraction of relatively short bamboo fibers,
wherein the second length sieve device receives the second width fraction and further separates the second width fraction into at least a third length fraction of relatively long bamboo fibers and a fourth length fraction of relatively short bamboo fibers.

95. The system according to claim 86, wherein the at least one length sieve device comprises:
at least one length sieve comprising an openings area which comprises multiple length sieve openings, and
a length sieve entry located at an upstream side of the openings area, wherein bamboo fibers which enter the length sieve via the length sieve entry are deposited on a deposition zone on the at least one length sieve,
a length sieve drive configured for vibrating the length sieve over a horizontal distance in order to move the bamboo fibers from the deposition zone over the length sieve and across the openings area, wherein relatively short bamboo fibers drop through the length sieve openings and wherein relatively long bamboo fibers travel across the length sieve openings without dropping through the length sieve openings,
a long fiber exit via which the first length fraction of relatively long bamboo fibers which have travelled across the openings area is discharged from the length sieve device, and
a short fiber exit via which the second length fraction of relatively short bamboo fibers which have dropped through the length sieve openings are discharged from the length sieve device,
wherein the openings area has the shape of at least one band having a band length and a band width, wherein the length sieve drive is configured to move the bamboo fibers across the band-shaped openings area,
wherein the length sieve openings are arranged in a staggered arrangement, wherein when seen in top view any straight line extending across the openings area extends over at least one length sieve opening.

96. The system according to claim 95, wherein when seen in top view:
the openings area is annular, wherein the openings area extends around the deposition zone, wherein the length sieve device comprises a circumferential wall which extends along a circumference of the at least one length sieve, wherein the long fiber exit comprises at least one opening in the circumferential wall and wherein the long fiber exit is located outwardly of the annular openings area and provided in the circumferential wall, or
the length sieve device comprises a left wall and a right wall, wherein the openings area extends as a band from the left wall to the right wall, wherein the deposition zone is located on an upstream side of the openings area, and the long fiber exit is located on the opposite, downstream side of the openings area.

97. The system according to claim 96, wherein the length sieve drive is configured for moving the length sieve in a gyrating manner, for moving the bamboo fibers from the deposition zone outwardly and away from the deposition zone and across the openings area,
or
wherein the length sieve drive is configured for moving the length sieve in an oscillatory manner, for moving the bamboo fibers from the deposition zone in a downstream direction across the openings area.

98. The system according to claim 95, wherein the length sieve drive is configured to move the length sieve only in a horizontal direction and to maintain the length sieve stationary or substantially stationary in a vertical direction, in order to maintain the bamboo fibers in a horizontal orientation and in contact with the length sieve and to prevent the bamboo fibers from becoming airborne.

99. The system according to claim 95, wherein the length sieve is a plate and wherein the multiple length sieve openings are formed in the plate.

100. The system according to claim 86, wherein at least one length sieve device comprises at least an upper length sieve having an upper long fiber exit and a lower length sieve having a lower long fiber exit which are mounted in a common housing, wherein the upper length sieve is positioned above the lower length sieve, wherein the lower length sieve comprises length sieve openings which are smaller than the length sieve openings of the upper length sieve, the at least one length sieve device comprising at least three exits:
an extra long fiber exit for bamboo fibers which do not pass the upper length sieve,
a medium long fiber exit for bamboo fibers which pass the upper length sieve but do not pass the lower length sieve,
a short fiber exit for bamboo fibers which pass the upper length sieve and pass the lower length sieve.

101. The system according to claim 86, wherein each length sieve drive comprises an unbalanced motor and a support assembly which provides freedom of movement of the length sieve in an X-direction and Y-direction, and no freedom of movement or substantially no freedom of movement in a Z-direction.

102. The system according to claim 85, comprising at least a first set and a second set placed in series, each set comprising:
at least one milling device, wherein each milling device comprises:
an upper milling disc having at least one entry opening,
a lower milling disc, and
a milling drive,
the upper milling disc being positioned above the lower milling disc, wherein the milling drive is configured to rotate at least one of the milling discs about a vertical axis,
a diameter subsystem comprising at least one diameter sieve device configured to receive bamboo fibers from the milling device of the same set, wherein each diameter sieve device comprises:
a diameter sieve comprising multiple diameter sieve openings having a size which determines a threshold diameter,
a diameter sieve entry via which the bamboo fibers enter the diameter sieve device and subsequently engage an upper side of the diameter sieve,
a diameter sieve drive configured for vibrating the diameter sieve over a vertical distance in order to let at least a portion of the bamboo fibers become airborne, in order to reorient the bamboo fibers to a vertical or substantially vertical orientation, wherein in operation the bamboo fibers having a diameter smaller than the width of the diameter sieve openings pass the diameter sieve through the diameter sieve openings, and wherein the bamboo fibers having a diameter larger than the size of the diameter sieve openings do not pass the sieve but remain on the upper side of the sieve,
at least one wide diameter exit via which the relatively wide bamboo fibers which have not passed the diameter sieve are discharged from the diameter sieve device,
at least one narrow diameter exit via which the relatively narrow bamboo fibers which have passed the diameter sieve are discharged from the diameter sieve device,
wherein the system comprises a feed trajectory between each set, the feed trajectory configured for feeding the relatively wide bamboo fibers which are discharged from the wide diameter exit of a set to the milling device of the next set in series,
the system comprising at least one return flow trajectory extending from the most downstream diameter sieve device to at least one milling device positioned further upstream, for returning a fraction of relatively wide bamboo fibers which have not passed the diameter sieve of downstream diameter sieve device to the milling device positioned further upstream for re-processing the fraction,
the system further comprising a merge trajectory, wherein the fractions of relatively narrow bamboo fibers which are discharged via the respective narrow diameter exits of the diameter sieve devices are entered into the merge trajectory via an entry opening in order to be merged into a merged fraction of relatively narrow bamboo fibers,
the system further comprising a further diameter sieve device configured for receiving the merged fraction of relatively narrow bamboo fibers and for separating the merged fraction of relatively narrow bamboo fibers into at least a first width fraction of relatively narrow bamboo fibers and a second width fraction of relatively wide bamboo fibers,
the system further comprising a length subsystem comprising at least a first length sieve device and a second length sieve device, the first and second length sieve device being positioned downstream from the further diameter sieve device,
wherein the first length sieve device receives the first width fraction and further separates the first width fraction into at least a first length fraction of relatively long bamboo fibers and a second length fraction of relatively short bamboo fibers,
wherein the second length sieve device receives the second width fraction and further separates the second width fraction into at least a third length fraction of relatively long bamboo fibers and a fourth length fraction of relatively short bamboo fibers.

103. A method of manufacturing bamboo fibers from bamboo parts, the method comprising:
supplying bamboo parts to the system according to claim 85,
milling the bamboo parts into bamboo fibers with the at least one milling device of the first set,
sieving the formed bamboo fibers with the at least one diameter sieve device of the first set, thereby separating the bamboo fibers in the first width fraction of relatively narrow bamboo fibers and the second width fraction of relatively wide bamboo fibers,
discharging the relatively narrow bamboo fibers which have passed the diameter sieve of the first set via the narrow diameter exit of the first set,
feeding the relatively wide bamboo fibers which are discharged from the wide diameter exit of the first set to the milling device of the second set via a feed trajectory which extends from the diameter sieve device of the first set to the milling device of the second set,
wherein a total flow of bamboo fibers which is passed on from one set to the next set decreases with each set.

104. The method according to claim 103, the method comprising merging the fractions of relatively narrow bamboo fibers which are discharged via the respective narrow diameter exits of the different diameter sieve devices into a merged fraction of bamboo fibers which follows the merge trajectory, wherein a total flow of bamboo fibers which follows the merge trajectory increases with each set.
